(19) United States
(12) Patent Application Publication
(10) Pub. No.: US 2003/0101333 A1
(43) Pub. Date: May 29, 2003

(54) Data processor

(75) Inventors: Hiromichi Ishikura, Kodaira (JP); Hajime Yasuda, Kokubunji (JP); Naoki Mitsuishi, Kodaira (JP); Kenichi Ishibashi, Kodaira (JP)

Correspondence Address: MILES & STOCKBRIDGE PC, 1751 PINNACLE DRIVE, SUITE 500, MCLEAN, VA, 22102-3833, US

(73) Assignee: Hitachi, Ltd.

(21) Appl. No.: 10/302,846

(22) Filed: Nov. 25, 2002

(30) Foreign Application Priority Data
Nov. 28, 2001 (JP) 2001-362871

(51) Int. Cl. G06F 9/00

(52) U.S. Cl. 712/226; 712/229

(57) ABSTRACT

No matter how large or small a data capacity in an address space is, code efficiency and data processing performance are improved without deteriorating the usage comfort of a CPU. Since a data processor is configured employing an instruction control unit (CONT) capable of changing interpretation of identical instructions according to dynamic switching of operation modes, dynamic switching can be made between the operation mode that limits data areas in an address space to give higher priority to higher code efficiency and quicker instruction fetch, and the operation mode that eliminates limitations on usable data areas to the fullest extent possible. Thereby, the advantages of instructions of contracted form and the like can be offered without deteriorating the usage comfort of the CPU.

### BACKGROUND OF THE INVENTION

The present invention relates to data processor technology for providing a CPU (central processing unit) with diversified instruction processing capabilities and a high-speed instruction execution capability, and more particularly to technology effectively applied to a microcomputer having plural operation modes different from each other in data area size.

An incentive to select a built-in microcomputer is CPU code efficiency. This is because a specified program must be stored in a limited capacity of a program memory (ROM) to pursuit system costs and higher CPU code efficiency results in more reduction in program capacity. High-level languages such as the C language, which have been widely used in recent years to improve system program development efficiency, generally tend to be poorer in code efficiency than assembler languages in the case where coding is performed directly by them. As a result, it has been recognized by the present inventor that there is a need for higher code efficiency including CPU architecture and compilers.

The CPU generally provides various addressing modes, taking its usage comfort into account. The addressing modes include those useful for improving CPU code efficiency, such as contracted form or shortened form of absolute address specification and register indirect addressing.

The contracted form of absolute address specification specifies an operand on a memory by an absolute address included in an instruction code. It limits access areas and specifies only the lower address of a CPU address to shorten instruction length. An upper address not specified in the instruction code is unconditionally fixed to a predetermined value within the CPU.

When the register indirect addressing mode is used, the contents of an address register specified by a register field of an instruction code are used as an address to specify an operand on a memory. Since the instruction code includes only a register number, the instruction length is smaller than in specifying an absolute address.

These addressing modes become more effective to improve code efficiency if they are used for instructions frequently occurring in programs. This not only contributes to an improvement in code efficiency but also reduces the number of CPU instruction fetch cycles and improves CPU execution speed. In this sense, it is advisable to use the contracted form addressing mode for instructions most frequently executed.

Since address spaces required by a microcomputer usually differ from each other according to control targets, the microcomputer is often provided with several operation modes different from each other in the size of address spaces and the like. Switching of the operation modes involves a reset operation, and when the reset operation is released, the CPU is enabled to make access to an address space in accordance with a specified operation mode. For example, in operation modes using small address spaces, general registers relatively small in length are used to calculate effective addresses, while, in operation modes using large address spaces, general registers relatively large in length are used to calculate effective addresses.

The CPU has flow control instructions for dynamically changing the value of the program counter (PC) to use plural small program blocks (subroutines) discretely placed on address spaces. For example, when a branch instruction is executed, the address (PC) of a next instruction is saved to a stack area. By executing an RTS instruction at the end of a subroutine of branch destination to re-set the value saved during execution of the branch instruction in the PC, control can return to a previous routine (a next execution address of the branch instruction). Information of the program counter to be saved is the number of bits corresponding to the capacity of a program space used by the CPU at that time.

In Japanese Published Unexamined Patent Application No. Hei 3(1991)-99321, an information processing technique is disclosed for providing different meanings for indirect specification in register indirect addressing. In short, it can be selected whether a value specified in an operand specification field of an instruction is processed as a register number or the value of a register specified in an operand specification field of an instruction is processed as a register number.

In Japanese Published Unexamined Patent Application No. Hei 3(1991)-271829, a technique for determining the length of data to be processed by instructions is disclosed. Data length is directly specified by a microprogram for each instruction program, or indirectly specified by an instruction code; if the latter is selected, data length indirect specification may not be made by an instruction code as in an interrupt handling process, and to avoid this situation, data specifying data length is possessed and the possessed data is made available for use.

### SUMMARY OF THE INVENTION

The inventor studied higher code efficiency, faster processing, and the flexibility of data processing. If the CPU is made to operate in an operation mode for small address spaces, an information amount of operand specification fields can be reduced, so that code efficiency is improved and the speedup of instruction fetch is achieved. Moreover, usable general registers increase substantially, leading to an improvement in CPU performance. However, this would limit data areas on a memory map accessible in the register indirect addressing mode or the like. The amount of data handled by the system must be smaller than a specifiable data range in the address space. Therefore, when a data capacity is larger than the data range even if a little, operation modes for large address spaces must be used.

Since data areas on a memory map accessible in contracted form addressing modes are limited to a relative small range, that is, a range specifiable by the contracted number of address bits, access to data in another address space requires full addresses to be specified. Therefore, in the case where a larger data area than specifiable in instructions of contracted form (shortened form) must be allocated in an address space, the contracted form addressing modes become wholly unusable, and code efficiency and CPU performance become lower in comparison with a system in which the contracted form addressing modes can be used.

When the CPU operates in an address space requiring address information relatively large in the number of bits as typified by 32-bit full addresses, to cope with the situation, the program counter is required to have a relatively large number of bits such as 32 bits. In this case, a value of the program counter stacked during execution of a branch instruction and a value unstacked and re-set in the program counter during execution of a subroutine return instruction both have a relatively large number of bits such as 32 bits. According to a study by the inventor, the following has been revealed. That is, if a program branch source and branch destination are within a limited area, the upper portions of addresses indicated by the program counter after execution of a branch instruction and a return instruction are identical, so that operations for saving and restoring data in that portion are meaningless and cause slower data processing speed and lower data processing performance.

An object of the present invention is to provide a data processor that can improve code efficiency and data processing performance without deteriorating the usage comfort of a CPU, no matter how large or small a data capacity in an address space is.

Another object of the present invention is to provide a data processor that can reduce the number of CPU instruction fetch cycles for execution of programs of identical functions, improve CPU performance, and improve the usage comfort of the CPU, no matter how large or small a data capacity in an address space is.

Another object of the present invention is to provide a data processor that, even when a larger data area than specifiable in instructions of contracted form (shortened form) must be allocated in an address space, can partially use contracted form addressing modes and arrest deterioration in code efficiency and CPU processing performance.

Another object of the present invention is to provide a data processor that enables processing programs manipulating localized data to use contracted forms (shortened forms) of absolute addresses and displacement.

Another object of the present invention is to provide a data processor that can improve CPU code efficiency by switching CPU addressing modes, and improve the processing speed and usage comfort of the CPU.

The above objects and other objects and new features of the present invention will become apparent from this specification and the accompanying drawings.

Typical features of the invention disclosed by this patent application will be briefly described below.

[1] The data processor according to the present invention includes a CPU capable of executing instructions, an address bus connected to the CPU, and a data bus connected to the CPU. The CPU includes an instruction control part or instruction control unit that can change interpretation of identical instructions according to operation modes, which can be changed based on the results of program execution by the CPU. The features of this means are twofold: first, interpretation of identical instructions can be changed according to operation modes; and second, the operation modes can be changed based on the results of program execution by the CPU.

The second point is one embodiment meaning that the operation modes can be dynamically changed. The term dynamical refers to a change of operation modes not accompanied by a CPU reset operation. For example, one preferred embodiment is to adopt a mode control register that can be accessed by the CPU and holds control data for deciding the operation modes. The operation modes can be dynamically changed according to a CPU operation program.

According to a different viewpoint on the dynamic switching of the operation modes, the CPU includes an instruction control part that can change interpretation of identical instructions according to operation modes, and internal control registers holding control data for deciding the operation modes. The internal control registers can be set variable after the CPU starts instruction execution upon release of a reset indication. As an embodiment of operation mode switching using an internal control register, the switching may be made by manipulating control data of the register by CPU instruction execution. As further different embodiment, if the data processor has an interrupt controller, it can allow the interrupt controller to change the setting of control data of the internal control register according to interrupt factors. Thereby, the operation modes can be dynamically switched according to CPU operation programs.

Regarding the point that interpretation of identical instructions can be changed according to the dynamically switchable operation modes, typical embodiments will be described.

A first embodiment of an interpretation change is a change of interpretation on the arrangement of address spaces usable as data areas.

A second embodiment of an interpretation change is a change of interpretation on the size of address spaces usable as data areas.

By thus changing interpretation of identical instructions according to operation modes dynamically switched, contracted forms (shortened forms) of absolute addresses and the like can be used only for processing programs manipulating localized data. In other words, when use is to be made of a larger address space as a whole in comparison with address spaces permitted for operation modes in which only contracted forms of absolute addresses and the like are used, addressing modes can be dynamically switched; that is, contracted form addressing modes are used to manipulate data localized in relatively small address areas, while addressing modes using full addresses are used for other address areas. Since contracted forms of absolute addresses and displacement can be partially used, program code efficiency and data processing speed can be improved. The usage comfort of the CPU also increases.

[2] From the foregoing description, although dynamic switching can be made between addressing modes using full addresses and contracted form addressing modes using a contracted number of address bits, when the contracted form addressing modes are selected, the number of address signal bits outputted to the address bus from the CPU must be equal to the number of bits defined in the addressing modes using full addresses. This is because an interpretation change is not accompanied by a CPU reset. Therefore, when an addressing mode is interpreted as contracted form, according to an interpretation change, the instruction control part fixes predetermined upper bits of an address signal outputted to the address bus to a predetermined value.

The predetermined value is, e.g., all bit logical values “1” or all bit logical values “0”. If both of them are used, the address space can be divided into a leading portion and an ending portion. In comparison with the case where only one of the logical value “1” and the logical value “0” is used, the contracted number of address bits decreases by one bit, achieving further improvement in code efficiency. In the case where both the logical value “1” and the logical value “0” are used, with which of them to fix may be decided according to instruction interpreting results, and the instruction control part directs the address output buffer to insert the logical value “1” or the logical value “0” to predetermined upper bits of output address information.

The predetermined value may be a value set in a register manipulated by instruction execution by the CPU. It may be, e.g., a value set in general registers and other internal registers of the CPU, or a value set in registers disposed in an address space of the CPU. Thereby, in addressing modes such as the contracted form addressing modes, data access can be made to any area in an address space defined by full addresses.

The instruction control part may change the length of general registers used, according to an interpretation change for the size of an address space usable as a data area. For example, when a 32-bit general register is used in the case where an addressing mode using full addresses is applied, if an interpretation change is made to apply a contracted form addressing mode, the lower 16 bits of a 32-bit general register specified in register specification information in an operand specification area are processed as a 16-bit register. Since the upper portion of the 32-bit general register is not used, the upper portion is recognized as an empty area and can be used as a 16-bit data buffer or the like. That is, it is advisable to create a CPU operation program so as to use such an upper empty area of general registers.

[3] As other cases of an interpretation change for identical instructions, the number of instruction address bits stacked or unstacked at branch or return can be changed. Since data localized in a relatively narrow range is generally used when an operation mode using the contracted form addressing modes is selected, a branch instruction and a return instruction can be interpreted to reduce the number of instruction address bits stacked or unstacked without trouble, and access data required for stack and unstack operations is small, contributing to faster data processing.

As other cases of an interpretation change for identical instructions, a change can be made of whether to add optional operations such as a shift operation on processing data by a data transfer instruction or data operation instruction. For example, access addresses of array data can be easily calculated. For example, in an array, when data is to be transferred to an address 2ⁿ times a base byte address thereof, the processing can be specified by one data transfer instruction provided with a shift operation. If instruction interpretation about whether to add such a shift operation is dynamically changed according to operation modes, the efficiency of program codes for data transfer processing and data operation processing in a specific operation mode can be improved and operation processing can be sped up.

[4] According to a further different viewpoint, the data processor of the present invention has a mode register operable by instruction execution by the CPU having an instruction control part and an execution part or an execution unit. A first value set in the mode register tells the instruction control part a first operation mode (advanced mode or maximum mode) in which an address space of a first capacity can be used as a data area. A second value set in the mode tells the instruction control part a second operation mode (middle mode) in which an address space of a second capacity smaller than the first capacity can be used as a data area. Thereby, the CPU can dynamically change the first and second operation modes different from each other in data area size. The CPU can dynamically change data areas made usable by instruction execution according to a specified operation mode.

Like the above description, since this means can also use contracted forms of absolute addresses and displacement in the dynamically switchable second operation mode, program code efficiency and data processing speed can be improved.

As one preferred embodiment, the mode register may be a register disposed in the address space of the CPU in both the first operation mode and the second operation mode. As another embodiment, with the mode register as an internal register of the CPU, there may be provided an interrupt controller that can set values in the mode register according to interrupt factors.

In a preferred embodiment of the instruction control part, in interpretation of addressing modes, when the first operation mode is specified, the general registers are made available for use with a first register length of the number of bits required to specify an address space of the first capacity, while, when the second operation mode is specified, the general registers are made available for use with a second register length of the number of bits required to specify an address space of the second capacity. As described previously, usage efficiency of the general registers can be improved.

### BRIEF DESCRIPTION OF THE DRAWINGS

FIG. 1 is a block diagram showing a detailed example of a CPU incorporated in a data processor according to the present invention;

FIG. 2 is a block diagram showing a single chip microcomputer, which is an example of a data processor according to the present invention;

FIG. 3 illustrates examples of the configuration of general registers and control registers of the CPU;

FIG. 4 illustrates usage patterns of the general registers;

FIG. 5 illustrates operation modes and address spaces of the CPU;

FIG. 6 illustrates CPU addressing modes such as absolute address mode and register indirect mode;

FIG. 7 illustrates a method of calculating an effective address by a register indirect addressing mode in an advanced mode or maximum mode and usage patterns of general registers at that time;

FIG. 8 illustrates a method of calculating an effective address by the register indirect addressing mode in the middle mode and usage patterns of the general registers at that time;

FIG. 9 illustrates a method of calculating an effective address by the addressing mode of absolute addresses in the advanced mode or maximum mode;

FIG. 10 illustrates a method of calculating an effective address by the addressing mode of absolute addresses in the middle mode;

FIG. 11 illustrates changes in data areas caused by switching between the middle mode and the advanced mode or maximum mode;

FIG. 12 illustrates a method of calculating an effective address by the register indirect addressing mode in the middle mode adopting the interpretation that the lower 8 bits of the general registers is used, and usage patterns of the general registers at that time;

FIG. 13 illustrates another example of instruction interpretation selected in the middle mode for the register indirect addressing mode;

FIG. 14 illustrates another example of instruction interpretation selected in the middle mode for the register indirect addressing mode; that is, 8-bit data of a general register is shifted two bits to the left to perform an add operation with a displacement;

FIG. 15 illustrates the instruction interpretation that, when the advanced mode is selected, for a particular data transfer instruction and an operation instruction, 32-bit data of a general register specified in the register indirect addressing mode is shifted two bits to the left to perform an add operation with a displacement;

FIG. 16 illustrates CPU configuration during switching of operation modes;

FIG. 17 illustrates address expansion embodiments in which the contents of a general register or a setting value of the expansion address setting register is used as an expansion address in the advanced mode or maximum mode;

FIG. 18 illustrates address expansion embodiments in which the contents of a general register or a setting value of the expansion address setting register is used as an expansion address in the middle mode;

FIG. 19 illustrates other address expansion embodiments in which the contents of a general register or a setting value of the expansion address setting register is used as an expansion address in the middle mode;

FIG. 20 illustrates changes of data areas caused by address expansion that uses the contents of a general register or a setting value of the expansion address setting register as an expansion address;

FIG. 21 illustrates a CPU enabled to switch data spaces using the expansion address setting register;

FIG. 22 shows another example of the CPU 2 enabled to switch data spaces using the expansion address setting register;

FIG. 23 is a timing chart of interrupt handling process;

FIG. 24 is a timing chart of interrupt return process;

FIG. 25 is an address map showing branch ranges when a branching range inhibition mode is not set;

FIG. 26 is an address map showing branch ranges when a branching range inhibition mode is set;

FIG. 27 is a timing chart at execution of a branch instruction when the branching range inhibition mode is not set in the advanced mode or maximum mode;

FIG. 28 is a timing chart at execution of a return instruction when the branching range inhibition mode is not set in the advanced mode or maximum mode;

FIG. 29 is a timing chart at execution of a return instruction when the branching range inhibition mode is not set in the advanced mode or maximum mode; and

FIG. 30 is a timing chart at execution of a return instruction when the branching range inhibition mode is set in the advanced mode or maximum mode;

### DETAILED DESCRIPTION OF THE PREFERRED EMBODIMENTS

<<Microcomputer>>

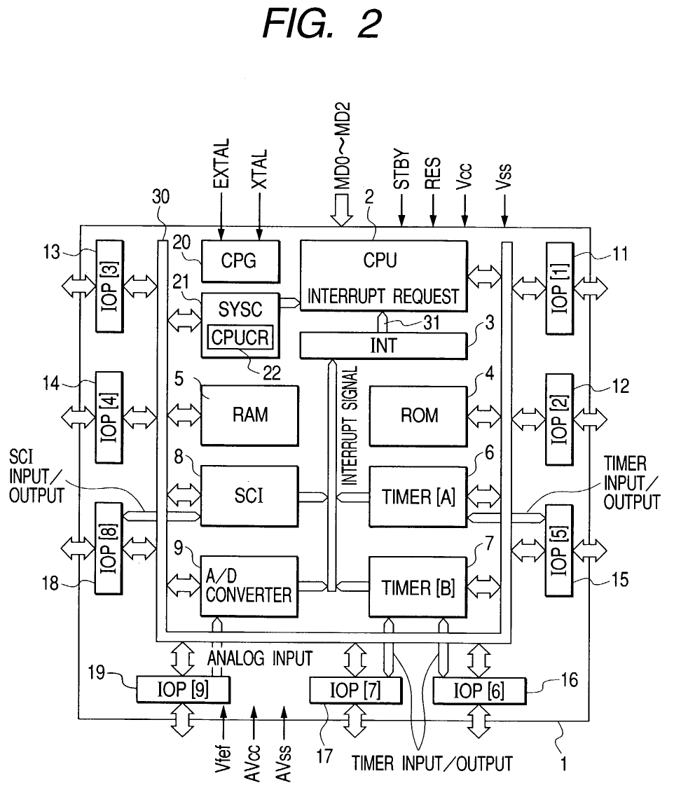

FIG. 2 shows a single-chip microcomputer, which is an example of a data processor according to the present invention.

A single-chip microcomputer shown in the drawing comprises: a CPU 2 responsible for control of the whole microcomputer; an interrupt controller (INT) 3; a ROM 4 as a memory for storing processing programs and the like of the CPU 2; a RAM 5 as a memory used as a work area of the CPU 2 and for temporary storage of data; a timer [A] 6; a timer [B] 7; a serial communication interface (SCI) 8; A/D converter 9; first to ninth input/output ports (IOP[1] to IOP[9]) 11 to 19; a clock oscillator (CPG) 20; and a system controller (SYSC) 21. These functional blocks and modules are formed on one semiconductor substrate such as a monocrystalline silicon by known semiconductor technology. CPUCR 22 is a control register disposed on a system controller 21.

The single-chip microcomputer 1 has input power terminals of ground level (Vss), power-source voltage level (Vcc), analog ground level (AVss), analog power-source level (AVcc), and analog reference voltage (Vref). It has dedicated control terminals of reset (RES), standby (STBY), mode control (MD0, MD1, and MD2), and clock input (EXTAL and XTAL).

The single-chip microcomputer 1 operates synchronously with a reference clock (system clock) produced based on crystal oscillators connected to the terminals EXTAL and XTAL of the CPG 20 or an external clock inputted to the EXTAL terminal. One cycle of the reference clock is referred to as a state.

The functional blocks of the single-chip microcomputer are connected to each other by an internal bus 30. The single-ship microcomputer incorporates a bus controller (not shown) that controls the bus. The internal bus 30 may include a control bus for read and write signals, and the like, as well as an internal address bus and an internal data bus, and the control bus may further include bus size signals or bus commands produced by coding the signals. The control bus may include system clocks and the like.

The functional blocks and modules are written to and read from by the CPU 2 through the internal bus 30. The data bus width of the internal bus 30 is 16 bits. The CPU 2 can read and write the internal ROM 4 and RAM 5 by one state.

The input/output ports 11 to 19 are shared with the address bus, data bus, bus control signals, or input/output terminals of the timers 6 and 7, SC18, and A/D converter 9. That is, the timers 6 and 7, SCI 8, and A/D converter each has an input signal, which is inputted to and outputted from the outside through the terminals shared with the input/output ports. For example, IOP[5], IOP[6], and IOP[7] are shared with the input/output terminals of the timers 6 and 7, and IOP[8] is shared with the input/output terminals of SCI 8. The input terminal of analog data is shared with IOP[9].

When a reset signal RES is provided to the single-chip microcomputer 1, the CPU 2 and the single-chip microcomputer 1 go into a reset state. When the reset is released, the CPU 2 reads a start address from a predetermined address and performs a reset exception handling process in which instructions are read from the start address. Thereafter, the CPU 2 successively reads instructions from the ROM 4 and the like and interprets them, and according to the result of the interpretation, performs data transfer with a data processing area or RAM 5, and timers 6 and 7. That is, the CPU 2 refers to data inputted from the input/output ports 11 to 19 and the like or commands inputted from the SC 18 and the like to perform processing, based on instructions stored in the ROM 4 and the like. Based on the processing results, the CPU 1 outputs signals to the outside, using the input/output ports 11 to 19, and timers 6 and 7, and the like to control different types of external connected devices.

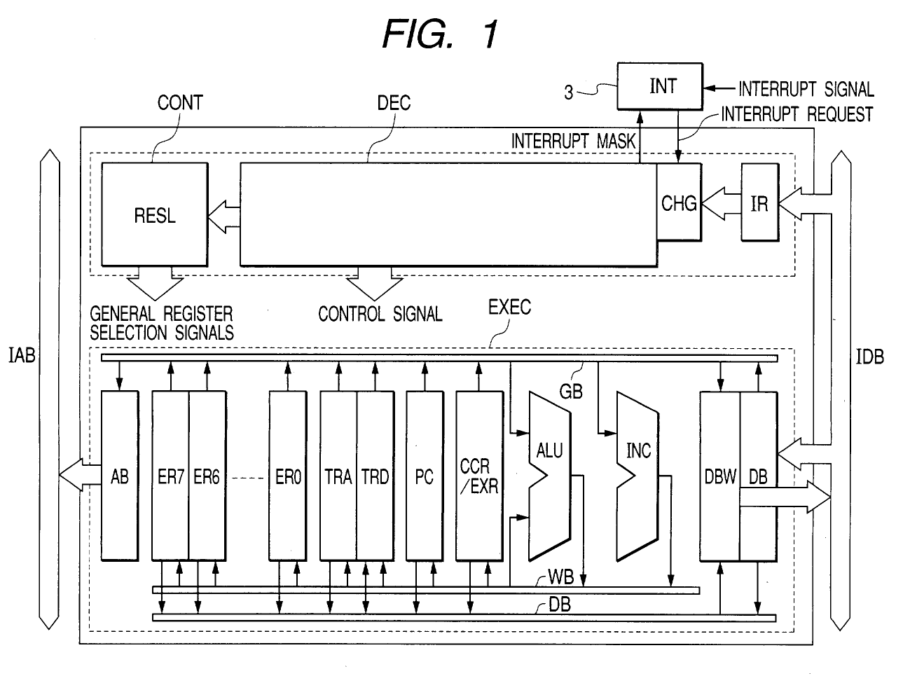

The states of the timers 6 and 7, SC 28, and external signals can be transferred to the CPU 2 as interrupt signals. The interrupt signals are outputted by the A/D converter 9, timer [A] 6, timer [B] 7, SC 18, and input/output ports 11 to 19, and the interrupt controller 3 inputs them and provides an interrupt request signal 31 to the CPU 2, based on specification of a predetermined register or the like. When an interrupt condition occurs, a CPU interrupt request is generated, and the CPU 2 stops processing in progress, branches to a predetermined processing routine after an exception handling process state to perform desired processing, and clears the interrupt condition. A return instruction is executed at the end of the predetermined processing routine, and the execution of the instruction resumes the stopped processing.

<<CPU>> FIG. 1 shows a detailed example of the CPU 2. The CPU 2 comprises an instruction control part (instruction control unit) CONT for interpreting an instruction and generating a control signal, and an execution part (an execution unit) EXEC for performing an operation, based on a control signal from the instruction control part. IDB and IAB are an internal data bus and an internal address bus contained in the internal bus 30, respectively.

The instruction control part CONT has an instruction register IR, an instruction change part CHG, an instruction decoder DEC, and a register selector RSEL.

The instruction register IR stores an instruction read via the internal data bus. The instruction decoder DEC interprets an instruction code stored in the instruction register IR and generates a control signal. The instruction decoder DEC is configured with, e.g., micro ROM, PLA (Programmable Logic Array), or hard-wired logic.

The instruction change part CHG, in response to an interrupt request signal from the controller 3, generates predetermined instruction codes for an interrupt exception handling process according to the hardware, and provides them to the instruction decoder DEC. The instruction controller 3 is provided with interrupt mask information from the instruction decoder DEC.

The register selector RSEL selects a general register or the like, based on information of a register field contained in an instruction code and the like.

The execution part EXEC includes general registers ER0 to ER7, program counter PC, condition code register CCR, extend register EXR, temporary registers TRA and TRD, arithmetic and logical unit ALU, incrementer INC, read data buffer RDB, write data buffer WDB, and address buffer AB. These blocks are connected to each other by the internal buses GB, DB, and WB.

The read data buffer RDB, write data buffer WDB, and address buffer AB temporarily latch data to interface with the internal buses IAB and IDB. The temporary registers TRA and TRD are used as required for internal operations of the microcomputer, such as, e.g., temporary storage of intermediate results of operations.

The read data buffer RDB temporarily stores instruction codes and data read from the ROM 4, ROM 5, internal I/O register, or external memory not shown. The write data buffer WDB temporarily stores write data to the ROM 4, ROM 5, internal I/O register, or external memory.

The address buffer AB has the function of temporarily storing an address read or written by the CPU 2, and also the function of incrementing stored contents. An address buffer having the increment function is described in Japanese Published Unexamined Patent Application No. Hei 4(1992)-333153.

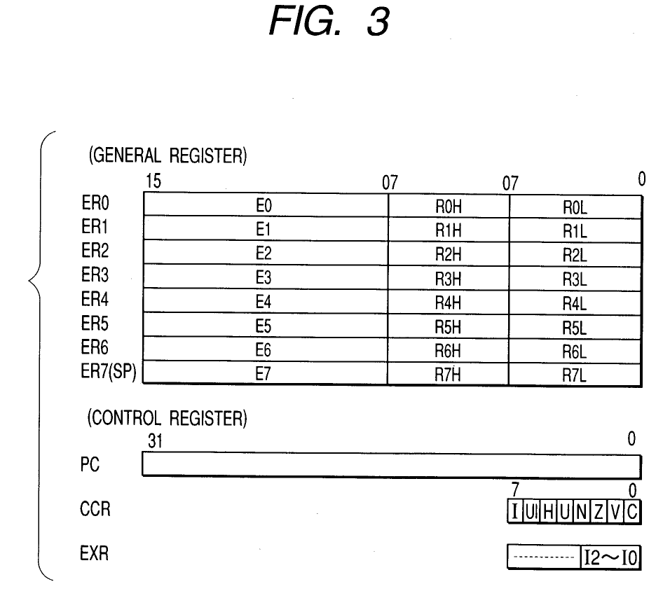

The arithmetic and logical unit ALU is used for various operations specified by instructions and the calculation of effective addresses. The incrementer INC is primarily used for addition of the program counter PC.

<<Register configuration>> FIG. 3 shows the configuration (programming model) of general registers and control registers of the CPU 2 to which the present invention is applied.

The CPU 2 has eight general registers, each 32 bits long. The general registers ER0 to ER7 all have the same function and can be used as both address registers and data registers.

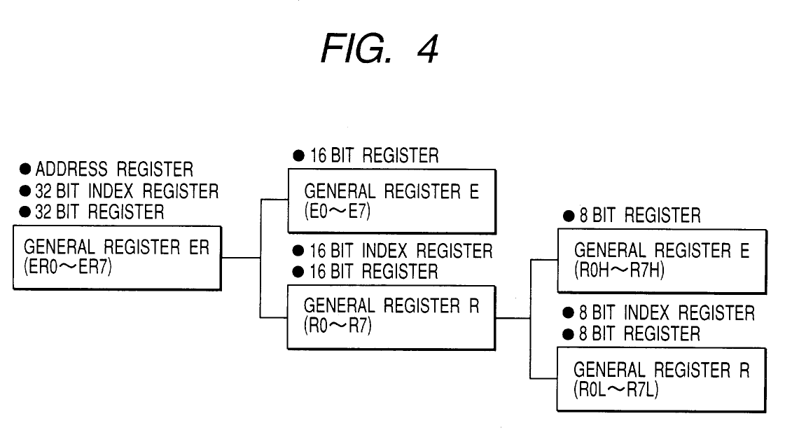

FIG. 4 shows use modes of the general registers. As data registers, they can be used as 32-bit, 16-bit, and 8-bit registers. As address registers and 32-bit registers, they are collectively used as general registers ER (ER0 to ER7). As 16-bit registers, the general registers ER are split for use as general registers E (E0 to E7) and general registers R (R0 to R7). These registers have the same function and up to sixteen 16-bit registers can be used. The general registers E (E0 to E7) may be referred to as expansion registers. As 8-bit registers, the general registers R are split for use as general registers RH (R0H to R7H) and general registers RL (R0L to R7L). These registers have the same function and up to sixteen 8-bit registers can be used. A different use method can be selected for each of the registers.

The general register ER7, which functions as both a general register and a stack pointer (SP), is implicitly used in exception handling process and subroutine branch. The exception handling process includes the interrupt handling process. By setting control registers (not shown) and the like, a stack pointer for subroutine branch and a stack pointer for exception handling process can be selected independently of each other.

As shown in FIG. 3, there are provided three control registers: PC (program counter), CCR (condition code register), and EXR (extend register).

The PC, having, e.g., 32 bits, indicates the address of the next instruction to be executed by the CPU 2. Although there is no particular limitation, since all instructions of the CPU 2 are organized in units of two bytes (word), the least significant bit is null and regarded as 0 during instruction reading.

The CCR, having eight bits, indicates an internal state of the CPU 2. It consists of eight bits including flags such as an interrupt mask bit (I), half carry (H), negative (N), zero (Z), overflow (V), and carry (C).

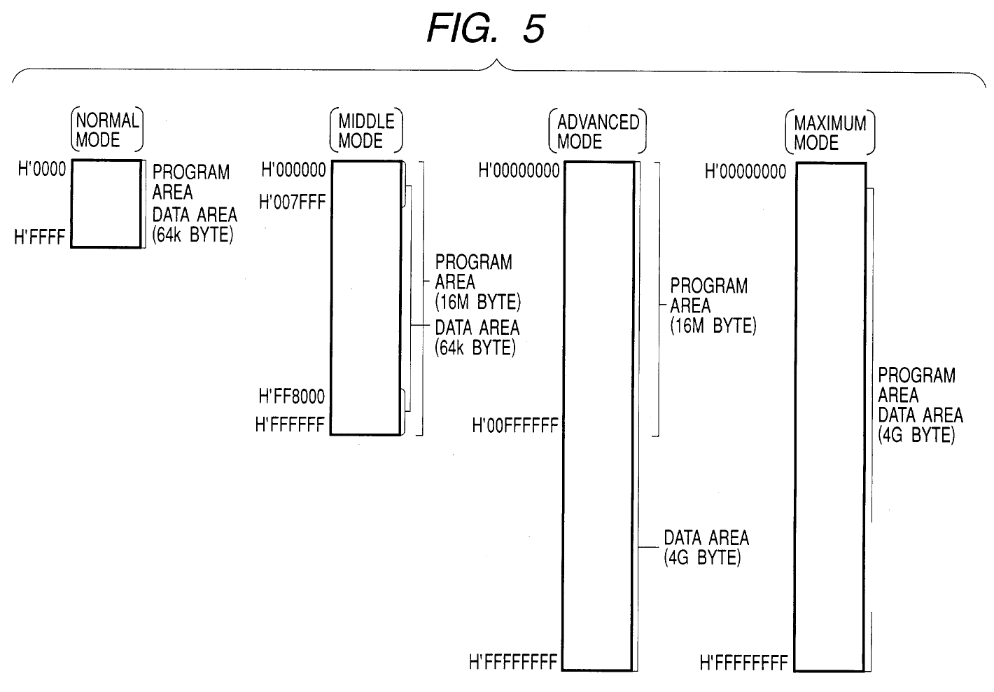

The extend register EXR, having eight bits, controls an exception handling process for interrupt and the like. It includes interrupt mask bits (12 to 10) and other bits.

<<Operation modes and address spaces of the CPU>> FIG. 5 shows operation modes and address spaces of the CPU. The CPU 2 has normal mode, middle mode, advanced mode, and maximum mode.

In the normal mode, the CPU 2 can access a 64K byte address space as a program area and a data area by 16-bit absolute addresses.

In the middle mode, the CPU 2 can access a 16M byte address space by 24-bit absolute addresses. Of the 16M byte address space, upper 32K bytes (H′000000 to H′007FFF) and lower 32K bytes (H′FF8000 to H′FFFFFF) are used as a data area and a program area. The remaining area is a program dedicated area. The middle mode is advantageously used when a program area is in shortage in the normal mode.

In the advanced mode, the CPU 2 can access a 4G byte address space by 32-bit absolute addresses. Of the 4G byte address space, upper 16M bytes (H′00000000 to H′00FFFFFF) are used as a program area and a data area. The remaining area is a data dedicated area. If a data area is in shortage in the middle mode, the advanced mode can be used.

In the maximum mode, the CPU can access a 4G byte address space by 32-bit absolute addresses. The 4G byte address space is shared as a program area and a data area. If a program area is in shortage in the middle mode, the advanced mode can be used.

Although there is no particular limitation, the normal mode, middle mode, advanced mode, and maximum mode can be selected depending on the state of the mode terminals MD0 to MD2. Changing an operation mode by the mode terminals MD0 to MD2 involves a reset operation by a reset signal RES or the like. In short, the CPU 2 operates in an operation mode specified by the mode terminals MD0 to MD2.

Changes from the middle mode to the advanced mode, and vice versa (or changes from the middle mode to the maximum mode, and vice versa) can be dynamically made without the CPU 2 being accompanied by a reset operation. The CPU 2, according to the dynamic change of operation modes, flexibly interprets identical instructions in line with the pertinent operation mode. That is, if a data area is in shortage in the normal mode, the middle mode or advanced mode can be used. In the middle mode, operands of a data area can be specified by 16 bits. Since upper eight bits of 24 bits of full addresses are H‘00’ or H‘FF’, if it is represented by the result of decoding an operation code or the like, address information of operand-specifying fields may be represented by 16-bit absolute addresses. In the advanced mode, address information of operand-specifying fields requires 32 bits. A smaller number of bits of address information of operand-specifying fields would contribute to higher program code efficiency and higher data processing efficiency as a result of a smaller number of memory accesses required to fetch instructions. As a result, even if use of the advanced mode is required in the interest of application rather than in terms of required data area size, if the operation mode is dynamically changed to the middle mode as required, shorter address information can be used for operand address calculations, and the length of instructions to be fetched becomes shorter because of the shorter address information, contributing to faster instruction fetch and higher program code efficiency. In addition, the number of usable general registers increases effectively, leading to improved CPU performance.

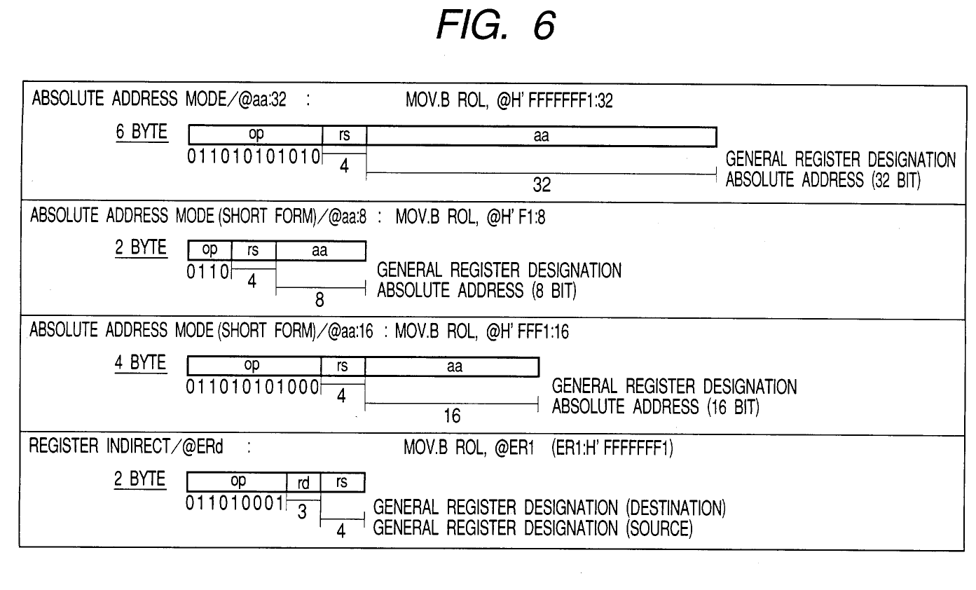

Hereinafter, a description is made of the CPU 2 that, according to dynamic changes of operation modes like the relationship between the middle mode and the advanced mode or maximum mode, flexibly interprets identical instructions in line with a pertinent operation mode.

<Addressing mode>> Several addressing modes of the CPU 2 are described with reference to FIG. 6. General addressing modes of the CPU 2 include an absolute address mode, an indirect mode, and the like in transfer instructions and operation instructions.

The absolute address mode specifies an operand on the memory by an absolute address included in an instruction code. In a contracted form of the absolute address specification, an access area is limited and only a lower address of a CPU address is specified to shorten an instruction length. An upper address not specified in the instruction code is fixed to a proper value within the CPU 2. An example of FIG. 6 shows, as the absolute address mode, three contracted forms: @aa:32 as full address space specification, @aa:8 as 8-bit address space specification, and @aa:16 as 16-bit address space specification. In the example of FIG. 6, a data transfer instruction (MOV.B) is used as an example, and op designates an operation code; rs, general register specification information (general register number) of a source side; and aa, absolute address information. The data transfer instruction can be mnemonically represented as follows:

\mathring{1} “MOV.W R0,@H'F1:8”

\mathring{2} “MOV.W R0,@H'FFF1:16”

\mathring{3} “MOV.W R0, @H'FFFFF1:24”

\mathring{4} “MOV.W R0,@H'FFFFFFF1:32”

When @aa:8 is used, upper 24 bits are set to all “1”, that is, H‘FFFFFF’, and when @aa:16 is used, upper 16 bits are extended with a sign. Although the above instructions mnemonically represented are functionally identical with each other, the instructions @aa:8 and @aa:16 of the contracted forms are shorter in length than the instruction @aa:32 specifying full addresses. Accordingly, if instructions specifying full addresses can be replaced by those of contracted forms, the capacity of instruction codes can be reduced and the number of instruction fetch cycles of the CPU 2 can be reduced, so that the execution speed of the CPU 2 can be improved.

The register indirect addressing mode specifies an operand on the memory by using the contents of an address register specified in a register field of an instruction code as an address. This instruction code has shorter instruction length than instructions specifying an absolute address because an address is indirectly specified by a register number. In the example of FIG. 6, rd designates a destination address register and rs designates a source register. Although there is no particular limitation, the CPU 2 of general register configuration shown in FIG. 3, in the register indirect addressing mode, uses En/RnH/RnL of the general registers as a 32-bit register ERn that is specified as a destination address register. An example of a transfer instruction using the addressing mode is mnemonically represented as “MOV.W R0,@ER2”. By using the register indirect addressing mode, 16M byte and 4G byte address spaces can be indirectly specified as data areas.

<<Middle mode>> If the addressing modes as typified by the above description are used for instructions occurring frequently in programs, code efficiency increases. Not only code efficiency increases, but also the number of instruction fetch cycles of the CPU 2 can be reduced, so that the execution speed of the CPU 2 can be improved. In this sense, such addressing modes should be used for instructions executed most frequently. From the viewpoint of this, the middle mode is adopted.

According to FIG. 5, for a 16M byte address space, a data area is limited to 64K bytes. Accordingly, 32 bits are not required for address specification for data access, 32 bits of ERn as general registers are not required for the calculation of effective addresses, lower 16 bits (Rn) can be referred to as an address register, and upper addresses can be forcibly fixed to a proper value, e.g., H'FF, H'00, or the like. The upper 16-bit register area not required, that is, En can be used for other purposes according to software.

Examples of use of the middle mode are described. A first example shows a case where the normal mode with an address space of 64 KB is used and the amount of handled data stays within 64 KB, but programs increase as the system becomes more sophisticated, with the result that a total amount of programs and data exceeds 64 KB. At this time, if the middle mode is used, program capacity can be easily increased. In a case where the general registers are used as address registers in the normal mode, upper 16 bits (En) can be used as a data buffer because they are not required. Upon transition to the advanced mode or maximum mode, since the upper 16-bits (En) must also be specified as part of an address, the upper portion of the general registers cannot be used as a data buffer.

In a second example, although the advanced mode or maximum mode is usually used, when data capacity is 64 KB or less, the middle mode is used. Since the number of general register increases effectively and can be used as data buffers, access to the memory decreases and data processing performance increases.

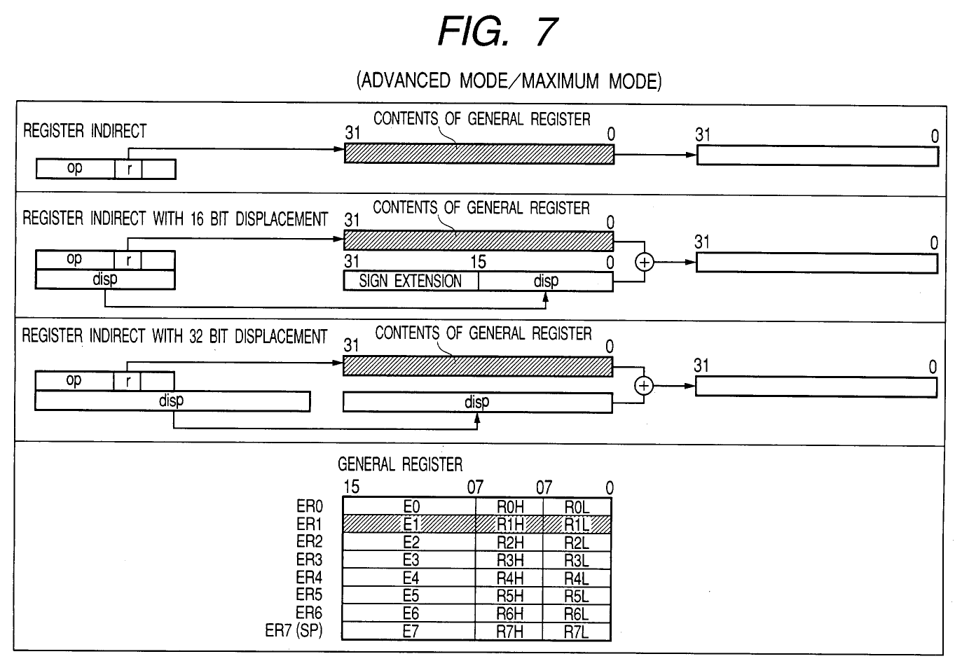

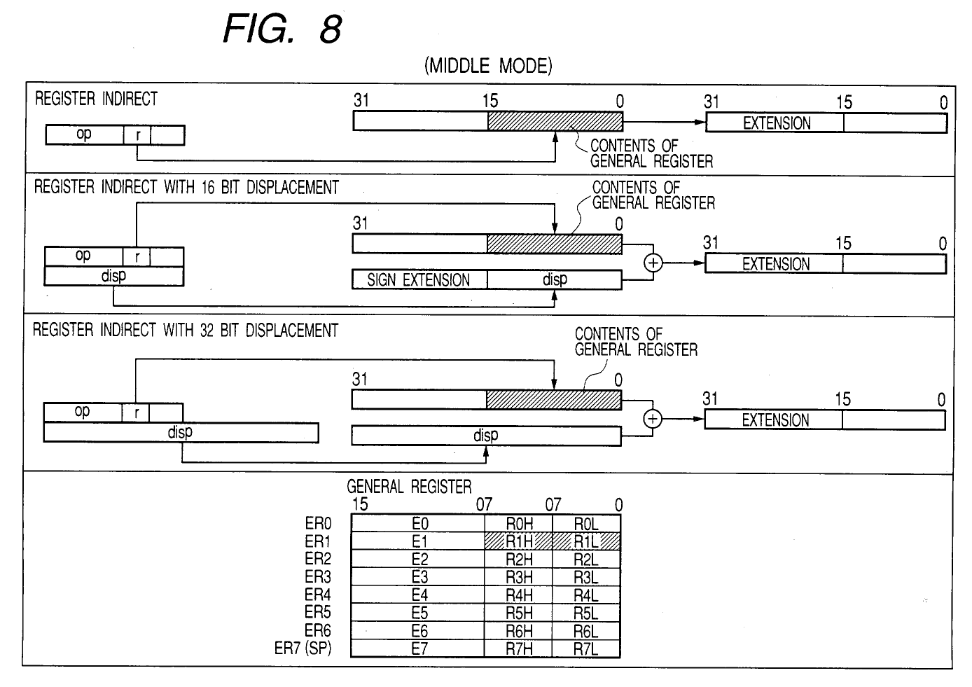

FIG. 7 shows a method of calculating an effective address by the register indirect addressing mode in the advanced mode or maximum mode and usage patterns of the general registers at that time. FIG. 8 shows a method of calculating an effective address by the register indirect addressing mode in the middle mode and usage patterns of the general registers at that time. In the middle mode, upper 16 bits of the general registers can be used as a data buffer because they may not be used as an address pointer. In the middle mode, address information outputted from the CPU 2 is extended with “1” or “0” in the upper 16 bits. The instructions concerned in the effective address calculations of FIGS. 7 and 8 may be identical. Differences of processing for instructions having identical instruction codes are provided by differences of instruction interpretation by the instruction decoder DCE.

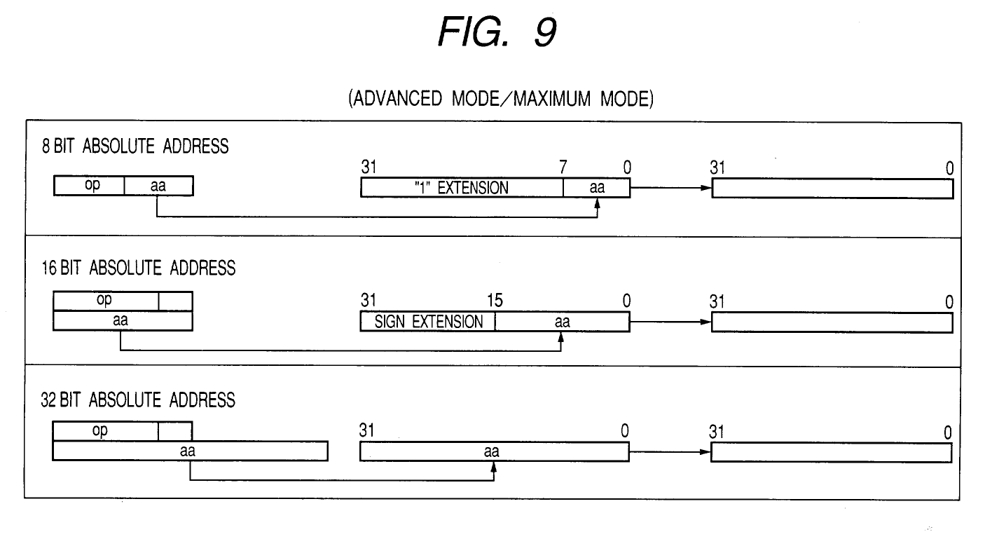

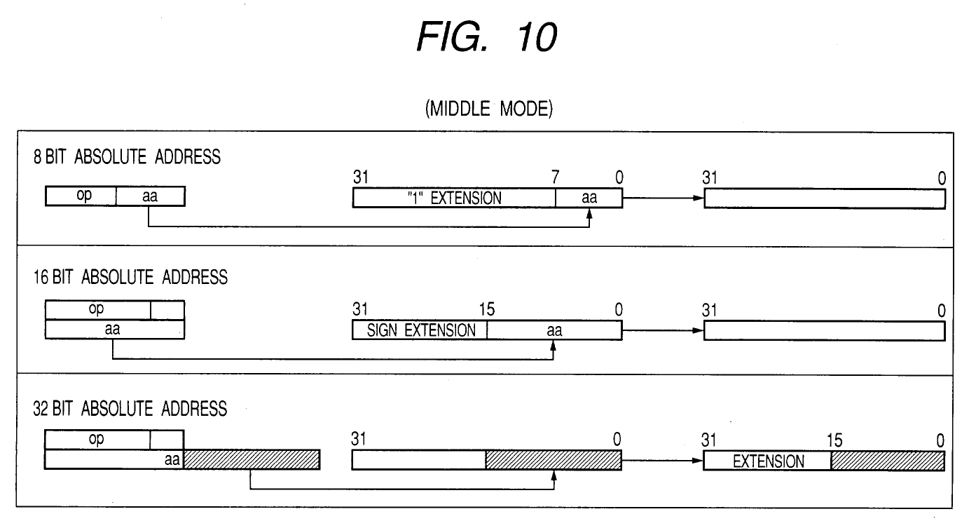

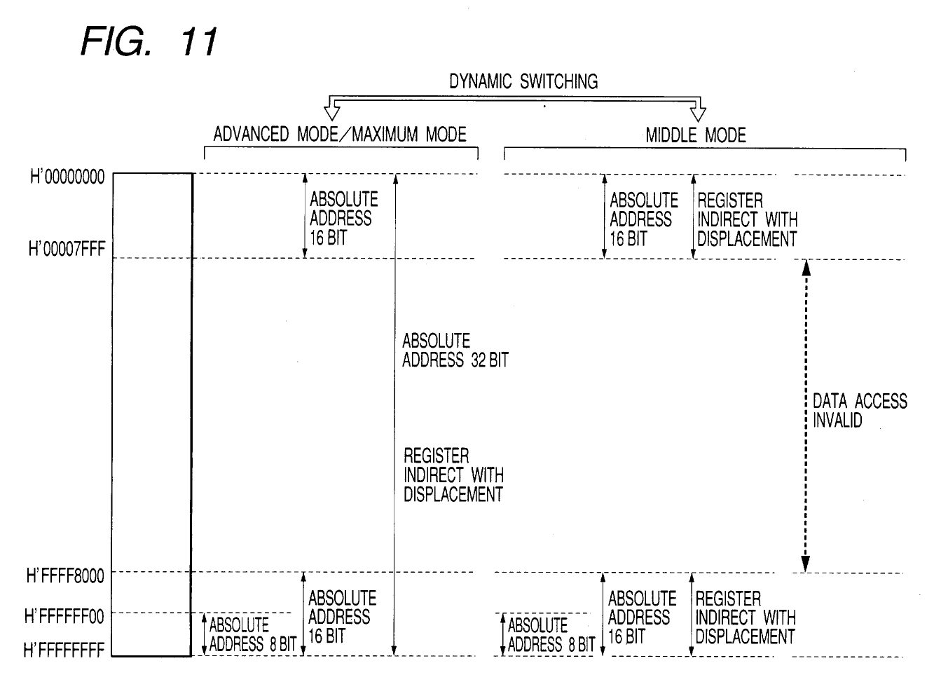

FIG. 9 shows a method of calculating an effective address by the addressing mode of absolute addresses in the advanced mode or maximum mode. FIG. 10 shows a method of calculating an effective address by the addressing mode of absolute addresses in the middle mode. In the middle mode of FIG. 10, the calculations of effective addresses are identical between use of a 16-bit absolute address and use of a 32-bit absolute address in an operand specification part. In short, even if a 32 bit absolute address is specified, the upper 16 bits are ignored. Although 32-bit absolute addresses can be used without problem, for program modules executed in the middle mode, if an absolute address of 16 bits or fewer is used in an operand specification field, code efficiency and instruction fetch speed can be improved.

<<Change of instruction interpretation>> FIG. 11 shows changes in data areas caused by switching between the middle mode and the advanced mode or maximum mode. The contents of the drawing are equivalent to an arrangement of accessible data areas in the addressing modes in FIGS. 7 to 10.

When switching is dynamically made between the middle mode and the advanced mode or maximum mode, the instruction decoder DEC changes interpretation about a given identical instruction in accordance with the operation mode. For instructions having the addressing mode of 8-bit absolute addresses and 16-bit absolute addresses, instruction interpretation for calculating an effective address is the same regardless of operation modes. For instructions having a register indirect addressing mode with displacement, 32-bit general registers are used in the advanced mode or maximum mode, while only the lower 16 bits of 32-bit general registers are used in the middle mode. For instructions having the addressing mode of absolute address 32 bits, 32 bits are used in the advanced mode or maximum mode, while only lower 16 bits are used in the middle mode.

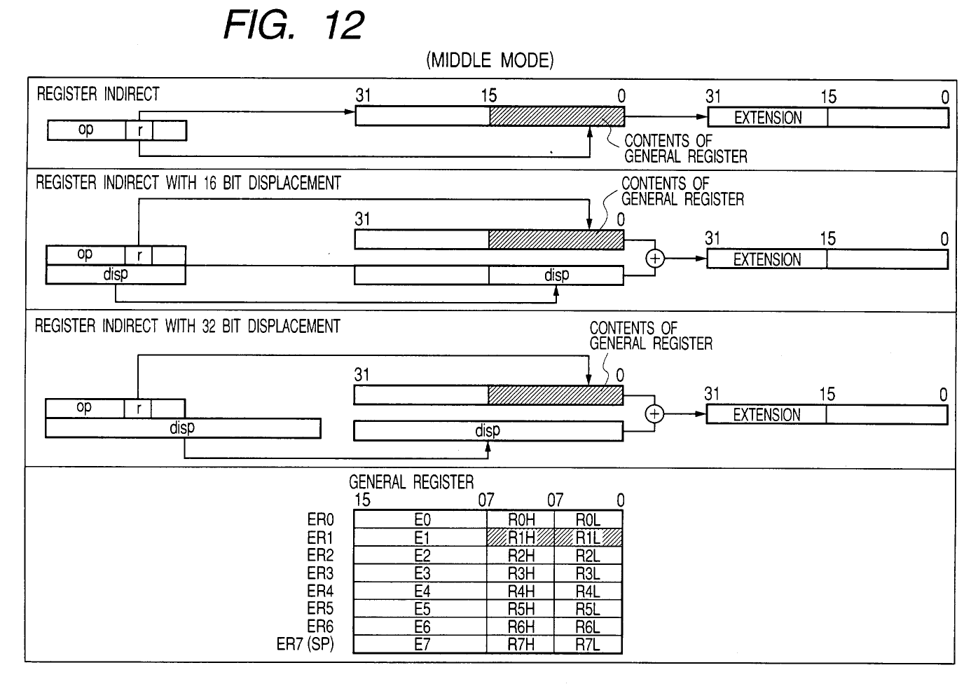

The contents of instruction interpretation changed by dynamic switching of operation modes depend on the logical configuration of the instruction decoder DEC. For example, for the register indirect addressing mode, in the middle mode, in addition to the interpretation that the lower 16 bits of the general registers are used as shown in FIG. 8, the interpretation that the lower 8 bits of the general registers are used as shown in FIG. 12 may be adopted. In this case, more free areas in the general registers can be used.

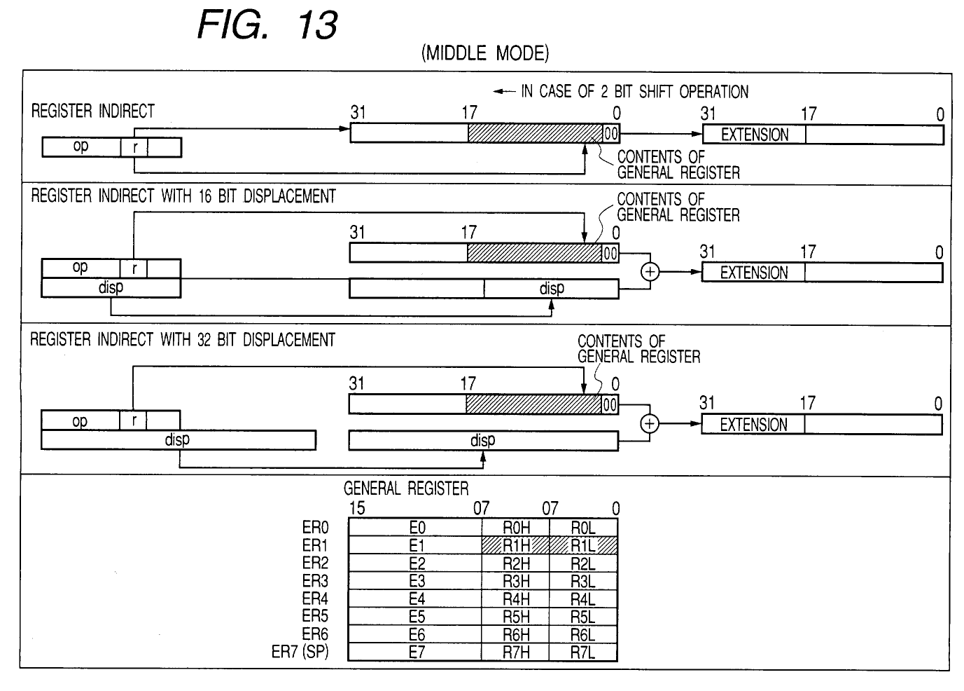

FIG. 13 shows another example of instruction interpretation selected in the middle mode for the register indirect addressing mode. In this example, when the middle mode is set, for a given data transfer instruction or operation instruction, interpretation for performing optional operations such as a shift operation on processing data is added. In an example of FIG. 13, the instruction is interpreted as follows: 16-bit data of a general register specified in the register indirect addressing mode is shifted two bits to the left to perform an add-operation with a displacement. This operation with a shift helps to facilitate the calculation of access addresses of array data. For example, in an array, when data is to be transferred to an address 2ⁿ times a base byte address thereof, the processing can be specified by one data transfer instruction provided with a shift operation. If instruction interpretation about whether to add such a shift operation is dynamically changed according to operation modes, the efficiency of program codes for data transfer processing and operation processing in a specific operation mode can be improved and operation processing can be sped up.

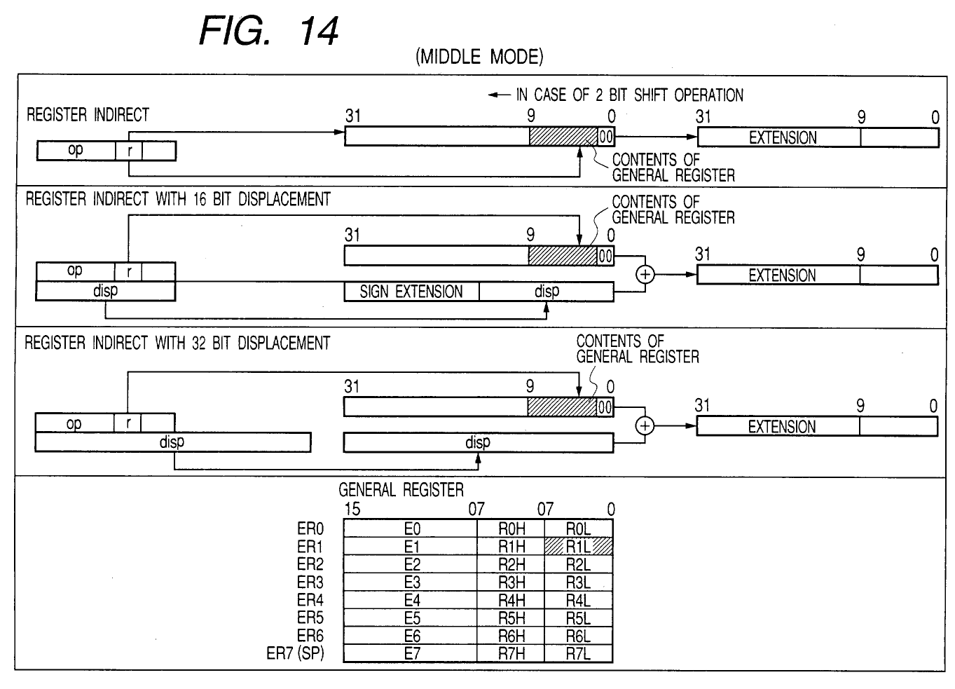

FIG. 14 shows another example of instruction interpretation selected in the middle mode for the register indirect addressing mode. A difference from FIG. 13 is in that 8-bit data of a general register specified in the register indirect addressing mode is shifted two bits to the left to perform an add operation with a displacement. Although an addressable range becomes smaller, the same effects of improved program efficiency and faster operation processing can be obtained.

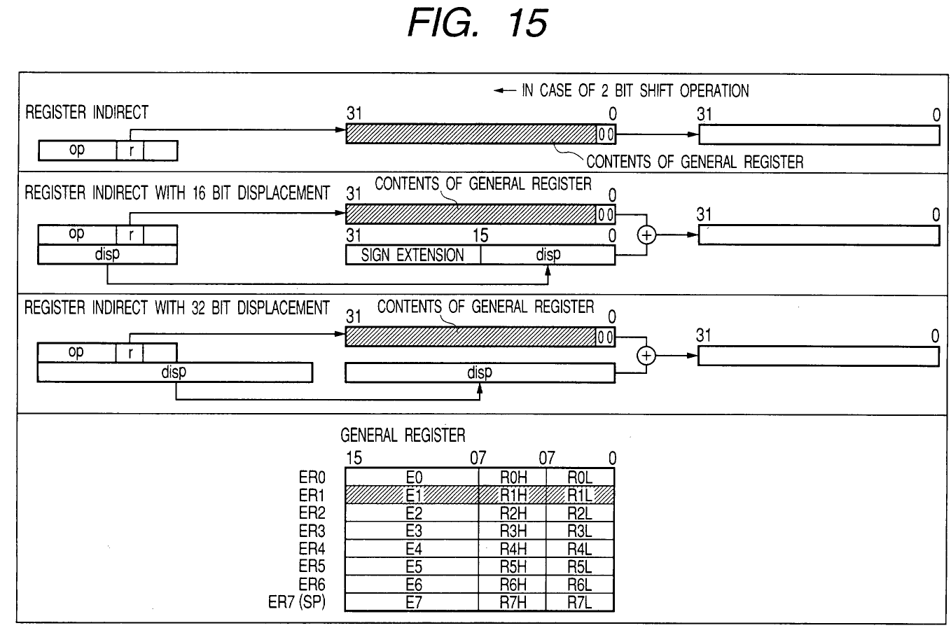

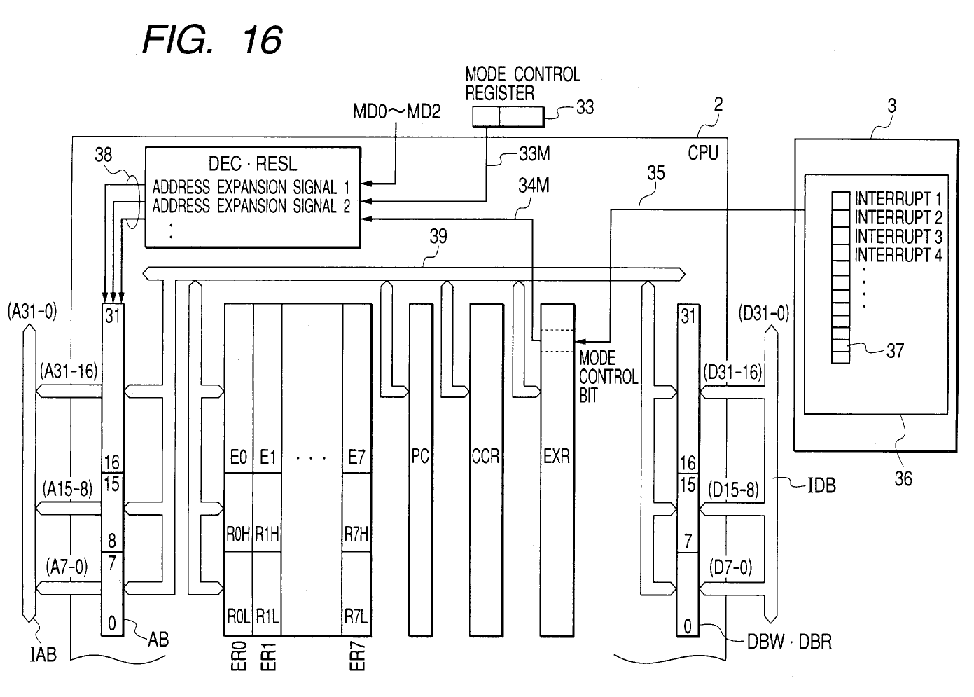

FIG. 15 shows an example of instruction interpretation having no direct relationship with the middle mode. That is, when a proper operation mode, e.g., the advanced mode is selected, for a particular data transfer instruction and an operation instruction, 32-bit data of a general register specified in the register indirect addressing mode is shifted two bits to the left to perform an add operation with a displacement.

<<Dynamic switching of operation mode>> FIG. 16 shows CPU configuration during switching of operation modes. An operation mode of the CPU 2 can be sent to the instruction decoder DEC in accordance with a state of the mode terminals MD0 to MD2.

A dynamic change of operation modes without involving a reset operation can be made by the setting of an operation mode control register 33 and the setting of mode control bits for the extend register EXR. The operation mode control register 33 is one register included in the CPUCR 22.

The mode control register 33, which is disposed or allocated in an address space of the CPU 2, can be freely updated by the CPU 2 making access through the address bus IAB and the data bus IDB. Switching of operation modes by use of the mode control register 33 can be made by the CPU 2 executing a data transfer instruction or the like for the mode control register 33. Although a mode control signal 33M of one bit of the mode control register 33 is typically shown in FIG. 16, actually an operation mode is specified according to logical combinations of mode control signals of plural bits. When mode specification by the mode control register 33 is different from mode specification by the mode terminals MD0 to MD2, the instruction decoder DEC gives a higher priority to the mode specification by the mode control register 33. In a reset operation of the CPU 2, the mode control bits of the mode control register are all disabled.

The setting values of the mode control bits of the extend register EXR can be changed by executing a control instruction such as a bit operation instruction of the CPU 2. As an alternative mode setting means, mode control bits may be assigned to the extend register EXR so that the interrupt controller 3 sets the mode control bits according to interrupt factors. That is, the interrupt controller 3 includes an interrupt-factor-specific mode control circuit 36, where an interrupt-factor-specific mode setting register 37 is disposed. Interrupt factors are assigned to bits of the interrupt-factor-specific mode setting register 37, and when an interrupt of an interrupt factor a bit associated with which is enabled occurs, a corresponding mode control bit is set by a signal 35 and other mode control bits are reset. Although a 1 bit mode control signal 34M and signal 35 which correspond to a mode control bit are typically shown in FIG. 16, actually an operation mode is specified according to a combination of logical values of mode control signals of plural bits. When mode specification by the extend register EXR is different from mode specification by the mode terminals MD0 to MD2, the instruction decoder DEC gives a higher priority to the mode specification by the extend register EXR. In a reset operation of the CPU 2, the mode control bits of the extend register EXR are all disabled or initialized.

In the case where operation modes are specified by the mode terminals MD0 to MD2, mode control register 33, and extend register EXR, a higher priority should be given to any one of mode specification by the mode control register 33 and mode specification by the extend register EXR.

The instruction decoder DEC, for the calculation result of an effective address, outputs an address expansion signal 38 to an address output buffer AB to perform address expansion according to an operation mode and instruction decoding results. Address expansion is performed in such a way that upper addresses are extended with “1”, “0”, or sign in an upper address, as described with respect to the addressing modes in the middle mode in FIGS. 8, 10, 12, 13, and 14. What expansion to perform is decided according to the result of decoding an operation code of an instruction. For example, an upper address required to access an accessible data area in FIG. 11 in the middle mode may be extended with “1” or “0”. Another case requiring address expansion is the case where instructions of the addressing mode of 8-bit absolute addresses and 16-bit absolute addresses are executed in the advanced mode or maximum mode.

In dynamic switching of operation modes, the instruction decoder DEC changes interpretation of an identical instruction according to operation modes; a typical example of the change contents is whether to perform address expansion as described previously. For example, for instructions of the addressing mode of 32-bit absolute addresses, address expansion is not required for execution in the advanced mode (see FIG. 9), while, for execution in the middle mode, the 16-bit upper address of the result of calculating an effective address is extended with “1” or “0” (see FIG. 10).

In dynamic switching of operation modes, another example of an interpretation change for an identical instruction by the instruction decoder DEC is specification of register length for general registers. This is done through the register selection circuit RESL from the instruction decoder DEC. For example, for instructions of the register indirect addressing mode with 32-bit displacement, a 32-bit general register (ERn) is specified for execution in the advanced mode (see FIG. 7), while, for execution in the middle mode, a register consisting of lower 16 bits of a specified 32-bit register is specified (see FIG. 8).

<<Data space specification>> For address expansion used as a method of specifying data spaces accessed in various addressing modes, according to the aforementioned description, as typified by “1” extension, “0” extension, and sign extension in the upper-address information of an effective address calculation result, several fixed values are provided and dynamically switched by hardware. Another means may be adopted. That is, to use the contents of a specified general registers as an expansion address, a programmable expansion address setting register is provided and a value set in the register is used as an expansion address.

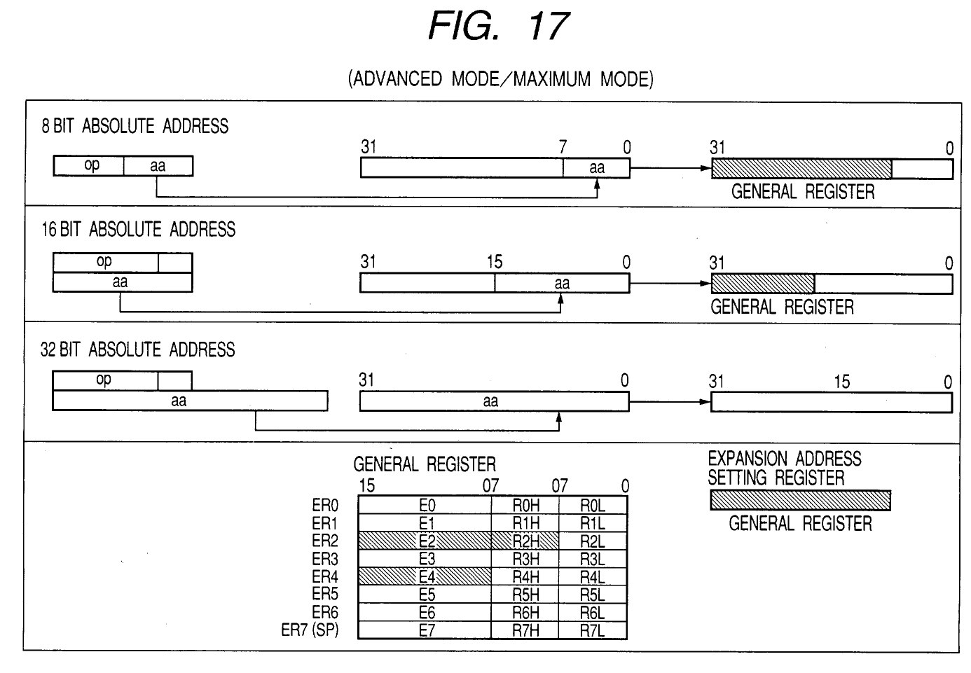

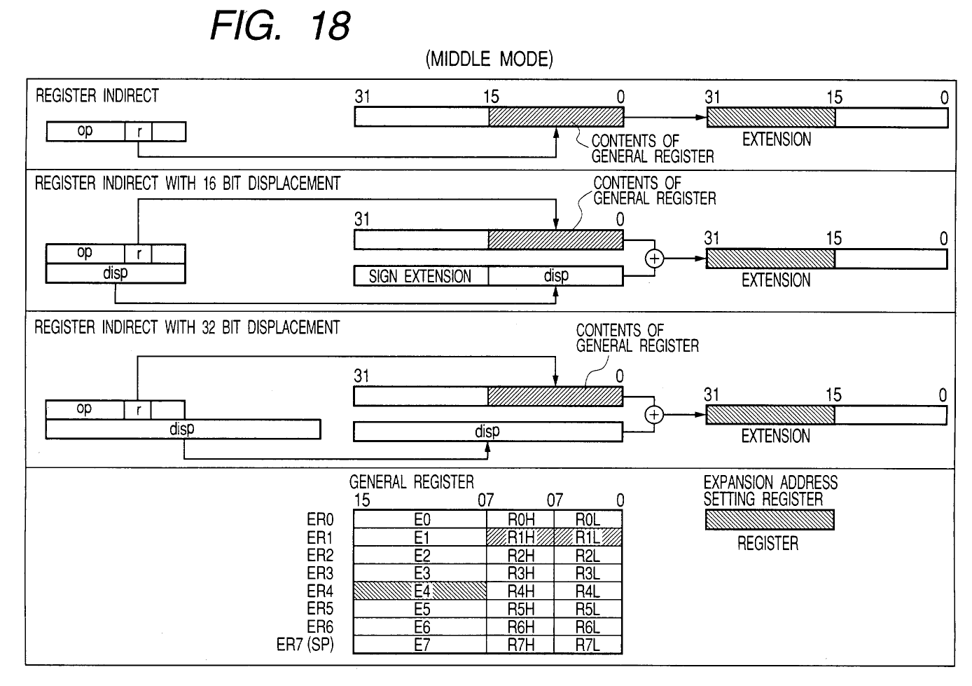

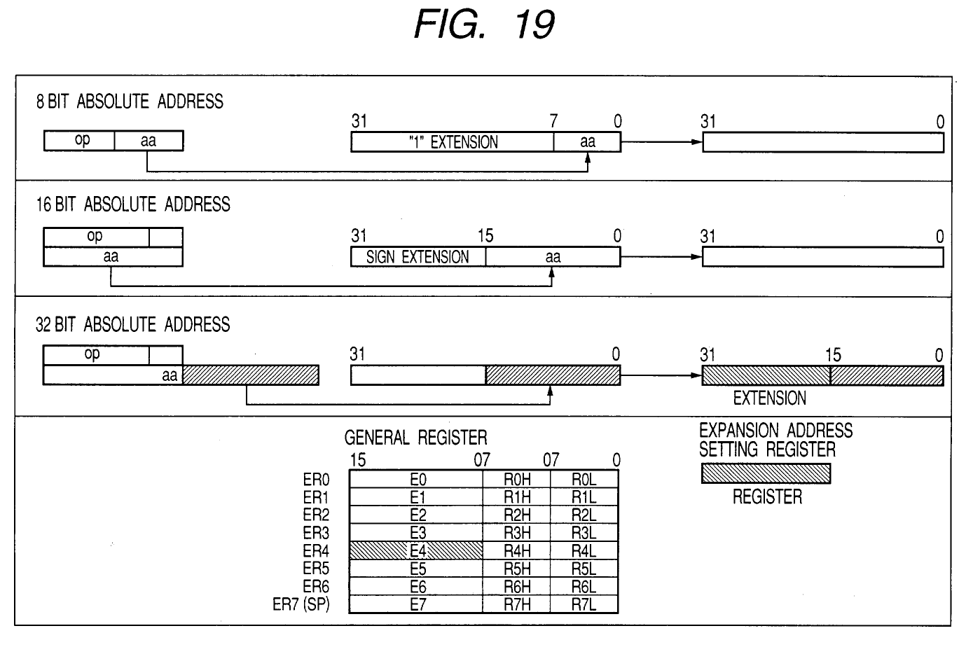

FIG. 17 shows address expansion embodiments in which the contents of a general register or a setting value of the expansion address setting register is used as an expansion address in the advanced mode or maximum mode. FIGS. 18 and 19 show address expansion embodiments in which the contents of a general register or a setting value of the expansion address setting register is used as an expansion address in the middle mode.

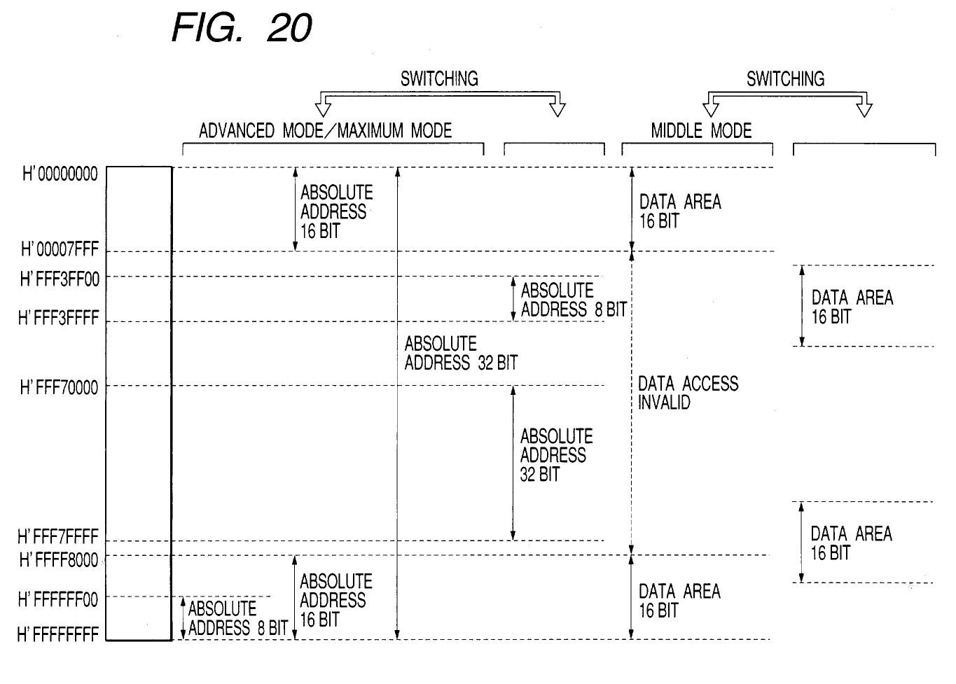

FIG. 20 shows changes of data areas caused by address expansion that uses the contents of a general register or a setting value of the expansion address setting register as an expansion address.

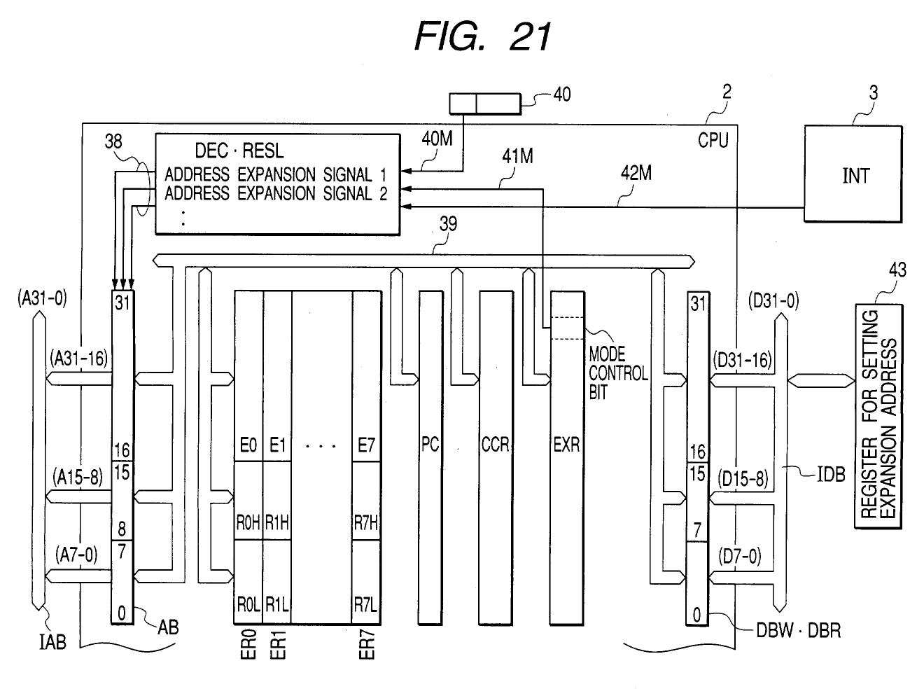

FIG. 21 shows the CPU 2 enabled to switch data spaces using the expansion address setting register. The expansion address setting register 43 is disposed in the address space of the CPU 2 and can be set to any value by instruction execution of the CPU 2. Whether the value of the expansion address setting register 43, “1” extension, or “0” extension is selected as an expansion address can be specified by referring to not only an instruction decoding result, but also a selection signal 40M from an expansion address selecting register 40, a selection signal 41M corresponding to a mode control bit of the extend register EXR, and a selection signal 42M outputted according to a given interrupt request from the interrupt controller. In other words, the instruction decoder DEC, by decoding the operation code of an instruction, as an expansion address used in the addressing mode of the instruction, determines whether one indicated by one of the signals 40M, 41M, and 42M can be selected, or one uniquely decided by the instruction decoding result is to be selected. In the case where one indicated by one of the signals 40M, 41M, and 42M can be selected, if the selection signal has a selection value other than disable, an expansion address specified by it is used. Otherwise, an expansion address uniquely decided by the instruction decoding result is used. For example, for the instruction interpretation result that, if the selection signal 41M indicates that a setting value of the expansion address setting register 43 can be used as an expansion address, it is used as an expansion address, if the selection signal 41M indicates such as selection state, the setting value of the expansion address setting register 43 is used as an expansion address.

As a result, when the CPU 2 executes instructions of contracted form, since the contents of the dedicated register can be used, any values set by software can be used as upper addresses not included in instruction codes of contracted form.

The expansion address selecting register 40 and the expansion address setting register 43 are registers included in the CPU 22. The expansion address setting register 43 may also be incorporated in the CPU 2.

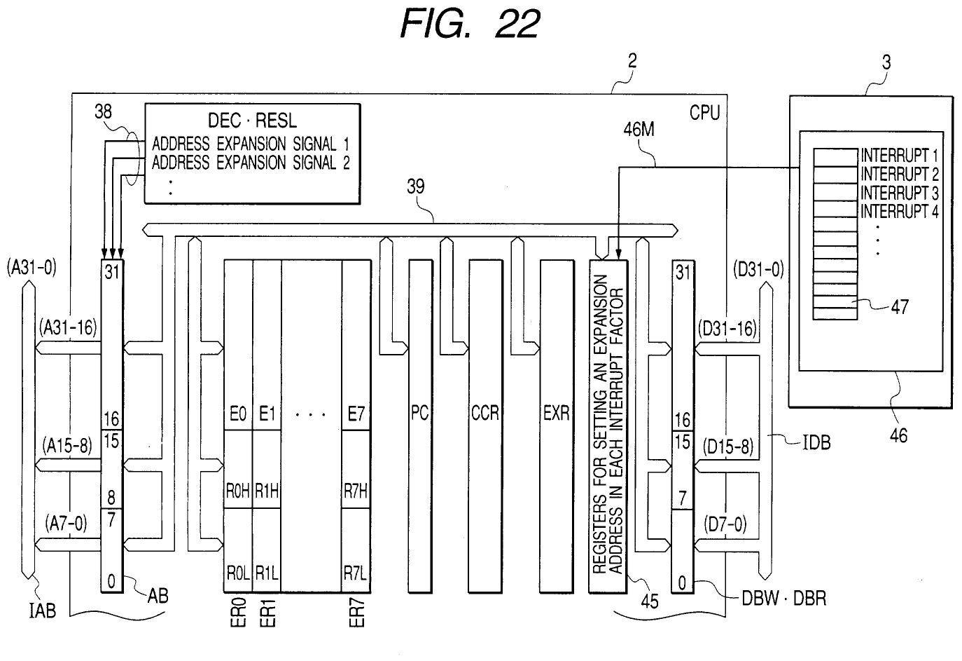

FIG. 22 shows another example of the CPU 2 enabled to switch data spaces using the expansion address setting register. In this example, a register 45 for setting expansion address in each interrupt factor is used. The register 45 for setting expansion address in each interrupt factor can have an expansion address for each of several interrupt factors. An expansion address set in the register 45 for setting expansion address in each interrupt factor is read into the internal bus 39 by a selection signal 46M outputted from an interrupt-factor-specific expansion address control circuit 46 and is transferred to the upper 16 bits of the address buffer AB. The selection signal 46M is made to correspond to factor bits of an interrupt factor register 47, and the factor bits are enabled for the duration of handling for corresponding interrupts and enabled to be outputted as the selection signal 46M at the timing of output of an effective address calculation result.

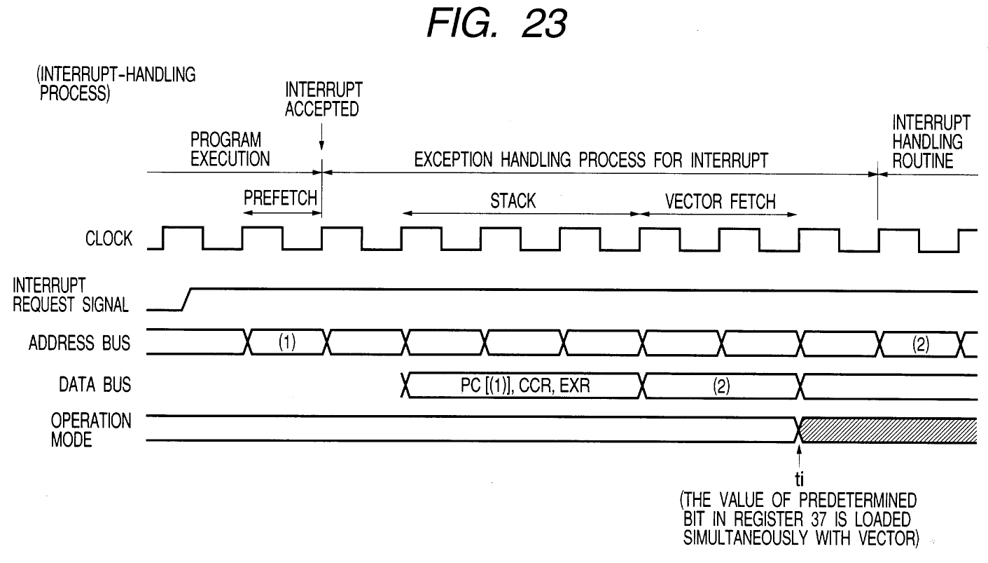

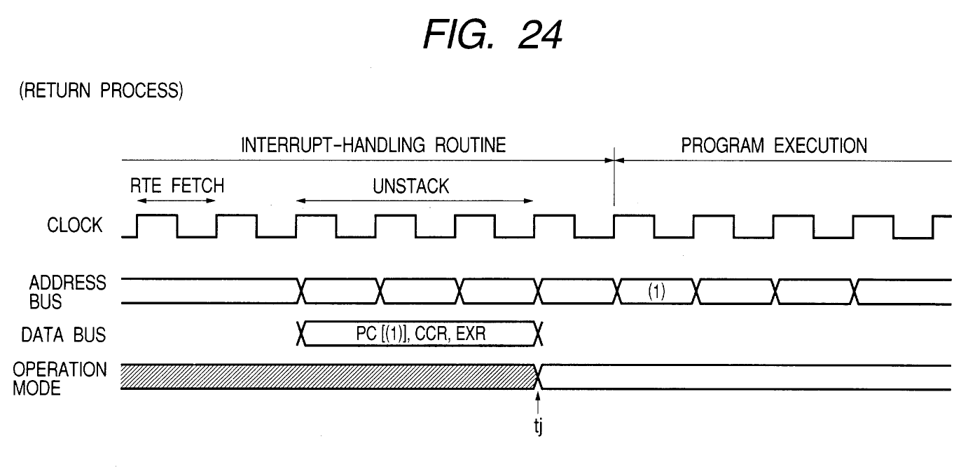

In the configuration of FIGS. 21 and 22, selectable expansion addresses can be dynamically switched based on software of the CPU 2 during an operation of the CPU 2.

<<Mode switching timing by interrupt>> A description is made of timing when setting of mode control bits and switching of data spaces are performed by interrupts. FIG. 23 shows a timing chart of interrupt handling process, and FIG. 24 shows a timing chart of interrupt return process. In the interrupt handling process, an operation mode is changed after the value of the program counter PC and other values are saved and before an interrupt handling routine is started. For example, in the configuration of FIG. 16, the value of a required bit of the interrupt-factor-specific mode setting register 37 is transferred through the control signal 35 at time ti of FIG. 23 and mode control bits are set. In the interrupt return process, an operation mode is changed after the value of the program counter PC and other values are restored and before a previous processing routine is started. For example, in the configuration of FIG. 16, a saved value of the extend register EXR is restored at time tj and the previous mode before execution of the interrupt handling process is reset.

<<Flow control>> The CPU 2 has flow control instructions for dynamically changing the value of the program counter PC in an instruction set. The flow control instructions include instruction designated as a Bcc (Branch conditional) instruction, JMP (Jump) instruction, JSR (Jump to subroutine) instruction, and RTS (Return from subroutine) instruction.

The Bcc instruction, under a given condition, adds a specified value to the program counter PC and causes a branch. The JMP instruction and the JSR instruction unconditionally causes a branch to an execution address specified in an operand or an effective address indicated by the contents of a specified register. The JSR instruction saves the address (value of the program counter PC) of a next instruction in a stack area during execution. By executing the RTS instruction at the end of a subroutine of a jump destination, a value saved during execution of the JSR instruction is re-set in the PC and thereby control can return to a previous routine (to the next execution instruction of the JSR instruction). Flow control instructions requiring save processing are collectively referred to as branch instructions, and instructions ordering return processing are collectively referred to as return instructions.

In the normal mode, the amount of data to be stacked and unstacked during execution of the JSR and RTS instructions is small, and execution speed is faster than in the advanced mode or maximum mode. This is because the advanced mode (program space: 16 MB/24-bit address) and maximum mode (program space: 4 GB/32-bit address) require the number of bits of the program counter PC of 24 bits and 32 bits, respectively, while, in the normal mode (program space: 64 KB/16-bit address), only 16 bits are valid as the program counter PC (bus width is assumed as 16 bits).

As described previously, in the advanced mode or maximum mode, if it is known in advance that the upper portions of addresses are the same before and after execution of the JSR and RTS instructions, operations to stack and unstack the upper portions of the addresses are not required. From the viewpoint of this, the CPU 2 shortens instruction addresses to be stacked or unstacked (save/restore) by placing the addresses of subroutines used in a required program within a fixed range and specifying a specific operation mode.

As a method of shortening the value of the program counter PC to be saved or restored during execution of the JSR/RST instruction when a specific operation mode is set, for example, only the lower 16 bits of the program counter PC are saved or restored. This is the same as the range at the time of saving and restoring in the normal mode. This can be achieved by fitting a series of programs within blocks of 64 KB each determined by the contents (address) of the 17th bit and upper bits of the program counter PC. As a result, save/restore processing during execution of the JSR/RTS instruction is the same between the advanced mode or maximum mode, and the normal mode. The programs may be placed in any of blocks of 64 KB each determined by the contents (address) of the 17th bit and upper bits of the program counter PC. If a branch and return to an area beyond the boundaries of the blocks of 64 KB each is required, the specific mode may be released immediately before execution of an instruction. Mode switching, as described previously, may be made by changing instruction interpretation of identical instructions by the instruction decoder DEC according to specification of a specific operation mode. Such a specific operation mode may be set or released according to the state of the mode terminals MD0 to MD2 and the setting state of the CPUCR 22. It goes without saying that the setting or release state of a specific operation mode is presented to the instruction decoder DEC.

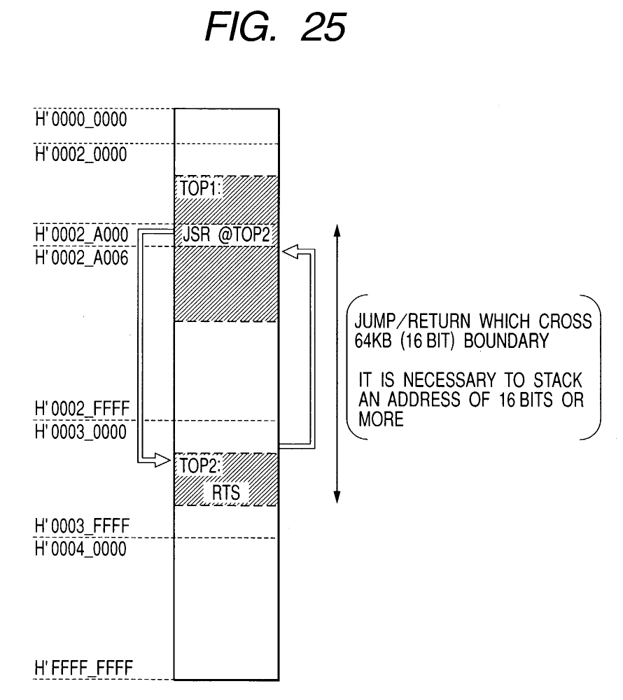

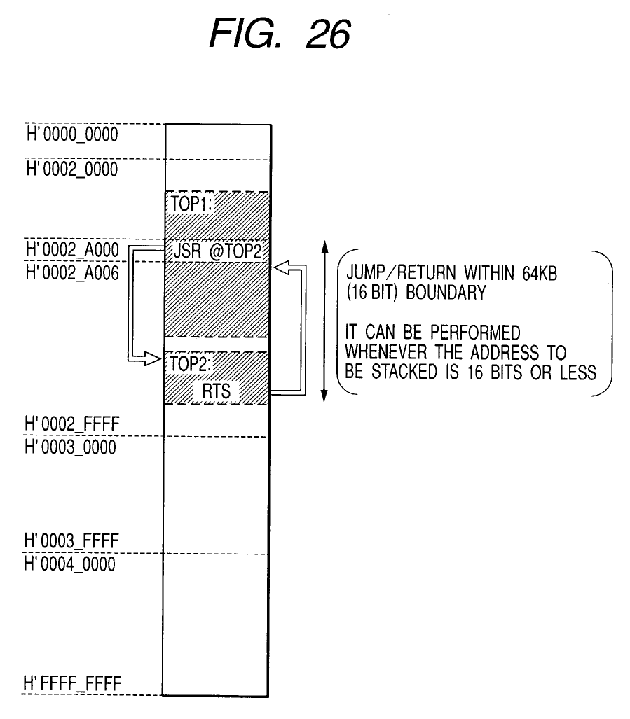

FIG. 25 shows branch ranges when the specific operation mode (branching range inhibition mode) is not set, and FIG. 26 shows branch ranges when the specific operation mode is set.

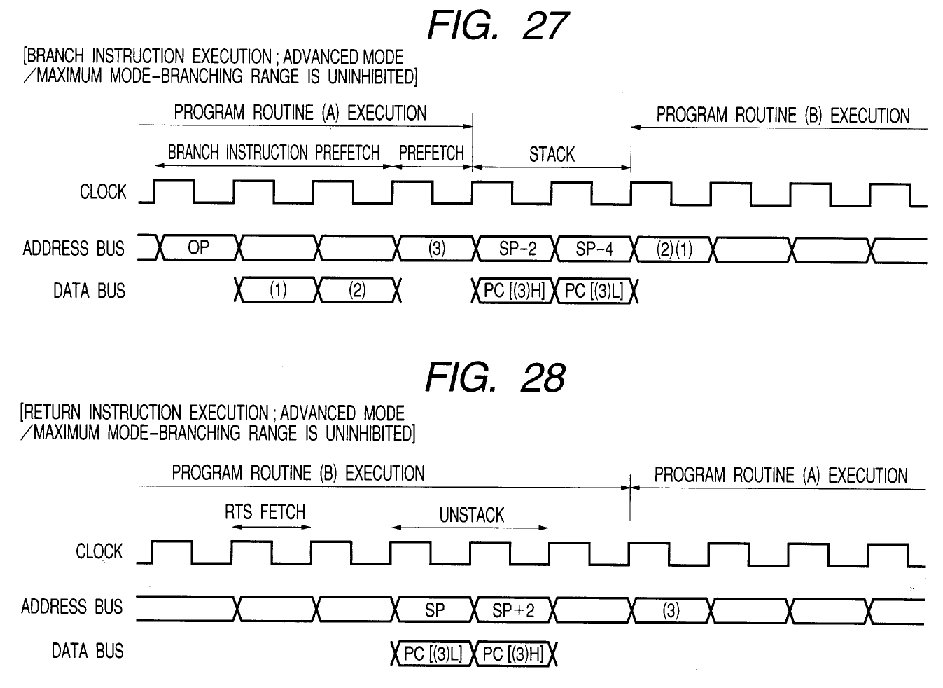

FIG. 27 shows a timing chart at execution of a branch instruction when the branching range inhibition mode is not set in the advanced mode or maximum mode. FIG. 28 shows a timing chart at execution of a return instruction when the branching range inhibition mode is not set in the advanced mode or maximum mode. As shown in the timing charts, the program counter PC is stacked and unstacked in two bus access cycles, respectively. This is because the program counter PC has 32 bits and bus accesses are performed in units of 16 bits (bus width is assumed as 16 bits).

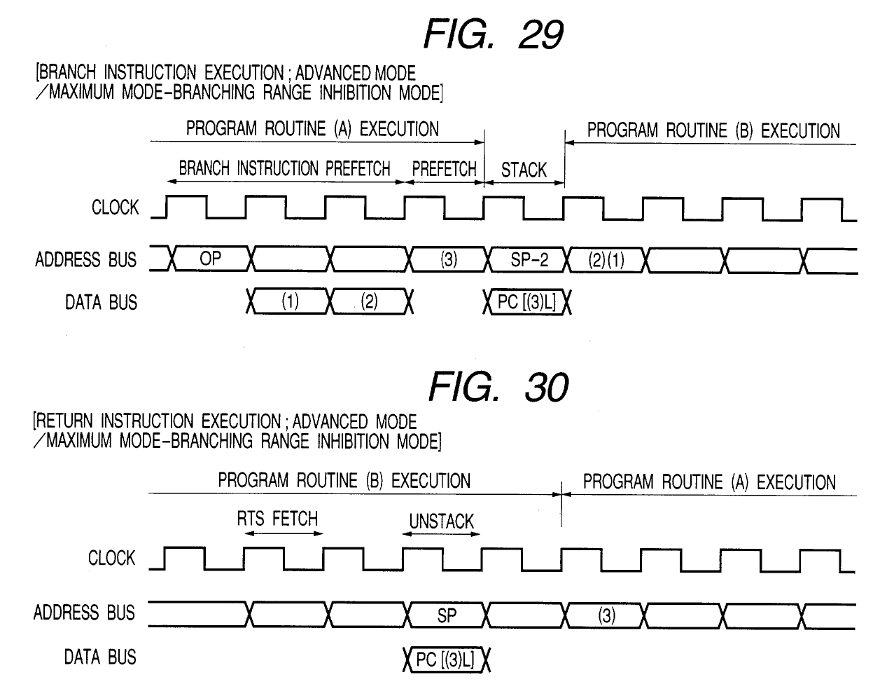

FIG. 29 shows a timing chart at execution of a branch instruction when the branching range inhibition mode is not set in the advanced mode or maximum mode. FIG. 30 shows a timing chart at execution of a return instruction when the branching range inhibition mode is set in the advanced mode or maximum mode. As shown in the timing charts, the program counter PC is stacked and unstacked in no more than one bus access cycle, respectively. This is because only the lower 16 bits of the 32-bit program counter PC are stacked and unstacked.

When the advanced mode or maximum mode and the middle mode are dynamically switched, the instruction decoder DEC may interpret the return and branch instructions, assuming that the branching range inhibition mode is set in the middle mode.

According to the data processor described above, effects described below can be obtained.

[1] In the middle mode, CPU performance is improved by limiting data areas because instruction length is reduced, instruction fetch is sped up, and the number of usable general registers increases. However, the data areas become smaller than in the advanced mode and maximum mode. In this case, since the advanced mode or maximum mode and the middle mode can be dynamically switched without resetting the CPU 2, a data area can be allocated for use anywhere in the full address space of the CPU 2. Data requiring quick access may be locally positioned in an area accessible in the middle mode. If the operation mode is switched to the advanced mode or maximum mode, other data can also be accessed. By thus providing a facility for dynamically switching the advanced mode or maximum mode and the middle mode during operation of the CPU 2, the advantages of the middle mode can be offered without deteriorating the usage comfort of the CPU when a wide data area is used. Accordingly, without making addition and change to an instruction set of the CPU 2, the hardware and potential processing capability of the CPU 2 can be used more effectively than conventional.

[2] Since data areas accessible by instructions of contracted form can be changed as shown in FIG. 20, the flexibility of system design increases and the performance of the CPU 2 can be offered to the fullest extent possible. For example, when I/O registers, internal RAM, and part of external addresses are allocated in an address space accessible by instructions of contracted form, in a 8-bit address range fixed for instructions of contracted form, a data area accessible by the instructions of contracted form is no more than 256 bytes of an 8-bit absolute address space. In this case, if the placement of such an 8-bit address space can be programmably changed according to the setting value of the expansion address setting register 43, there can be provided plural 8-bit absolute address spaces accessible by instructions of contracted form, to each of which internal I/O registers, internal RAM, and part of external addresses are allocated.

For the reason described above, data spaces accessible by instructions of contracted form increase substantially. As a result, the ratio of instruction codes of full address specification replaceable by contracted form, or the ratio of @aa:16 replaceable by @aa:8 increases, so that code efficiency can be further improved and the performance of the CPU 2 can be improved.

[3] Since data areas can be programmably specified, limitations on data spaces accessible by instructions of contracted form and data capacity are substantially removed.

[4] By setting a specific operation mode such as the branching range inhibition mode, the data amount of the program counter PC stacked during execution of JSR and RST can be reduced, so that the amount of a stack memory used can be reduced and subroutine branch and return operations can be sped up. Since such specific operation mode can be dynamically switched, while the function of branch and return in a wide range in accordance with the full address of the program counter PC can be satisfied, the performance of the CPU 2 can be improved.

Hereinbefore, the present invention has been described based on preferred embodiments, but it goes without saying that the present invention is not limited to the preferred embodiments and may be modified in various ways without departing from the main purports of the present invention.

For example, CPU operation modes are limited to the above described operation modes and the CPU can change a manageable maximum number of address bits and data bits as required according to operation modes. The CPU general register configuration is not limited to eight 32-bit general registers. According to the number of data bits on which the CPU can operate in parallel, the number of bits of general registers can be changed. The types of peripheral circuits of the data processor, internal bus configuration, and the like can be changed as required. Processing added according to operation modes dynamically set is not limited to shift processing and may be addition, subtraction, and other operation processing. The data processor is not limited to a microcomputer. It can also apply to a communication LSI, image processing LSI, and the like of a system-on-a-chip.

The forgoing description has been primarily made of the case where the present invention applies to a data processor that incorporates a CPU having the register indirect addressing mode and the contracted form addressing mode. The present invention is not limited to it and can apply to various data processors.

Effects of the invention disclosed by the present patent application will be briefly described below.

Since a data processor is configured employing an instruction control part capable of changing interpretation of identical instructions according to dynamic switching of operation modes, dynamic switching can be made between the operation mode that limits data areas in an address space to give higher priority to higher code efficiency and quicker instruction fetch, and the operation mode that eliminates limitations on usable data areas to the fullest extent possible. Thereby, the advantages of instructions of contracted form and the like can be offered without deteriorating the usage comfort of the CPU.

Contracted forms of absolute addresses and the like are made usable in processing programs that operate on data localized by dynamically switching accessible address spaces during execution of instructions of contracted form that limit an accessible address space and require no full address specification, with the result that code efficiency can be improved and processing can be sped up.

Since the amount of information to be stacked and unstacked is changed according to dynamically switchable operation modes, data processing can be sped up without wholly shutting out branch processing in a wide range.

What is claimed is:

1. A data processor comprising:
a CPU capable of executing instructions;
an address bus coupled to the CPU; and
a data bus connected to the CPU,
wherein the CPU includes an instruction control unit that can change interpretation of identical instructions according to operation modes, and
wherein the operation modes can be changed based on the results of program execution by the CPU.

2. The data processor according to claim 1, further comprising:
a mode control register that is capable of accessing from the CPU and holds control data for determining the operation modes.

3. A data processor comprising:
a CPU capable of executing instructions;
an address bus coupled to the CPU;
a data bus connected to the CPU; and
an internal control register which holds control data to determine the operation modes,
wherein the CPU includes an instruction control unit that can change interpretation of identical instructions according to operation modes, and an internal control register holding control data for deciding the operation modes, and
wherein the internal control registers can be set variable after the CPU starts instruction execution upon release of a reset indication.

4. The data processor according to claim 3, further comprising:
an interrupt controller,
wherein the interrupt controller changes the setting of control data of the internal control register according to interrupt factors.

5. The data processor according to claim 1,
wherein the interpretation change for identical instructions by the instruction control unit is interpretation change for the disposition of address spaces usable as data areas.

6. The data processor according to claim 1,
wherein the interpretation change for identical instructions by the instruction control unit is interpretation change for the size of address spaces usable as data areas.

7. The data processor according to claim 6,
wherein, when allowing use of an address space smaller than an address space represented by the number of bits of the address bus by interpretation change for the size of address spaces usable as data areas, the instruction control unit fixes predetermined upper bits of an address signal outputted to the address bus to a predetermined value.

8. The data processor according to claim 7,
wherein the predetermined value is all bit logical values “1” or all bit logical values “0”.

9. The data processor according to claim 7,
wherein the predetermined value is a value set in a register manipulated by instruction execution by the CPU.

10. The data processor according to claim 7,
wherein the CPU includes an address output buffer coupled to the address bus, and
wherein the address output buffer can fix predetermined upper bits of output address information to the predetermined value according to a command from the instruction control unit.

11. The data processor according to claim 5,
wherein the instruction control unit changes the length of general registers used, according to an interpretation change for the size of an address space usable as a data area.

12. The data processor according to claim 1,
wherein the interpretation change for identical instructions is a change of the number of address bits of a program address stacked in a branch operation, and a change of the number of address bits of a program address unstacked in a return operation.

13. The data processor according to claim 1,
wherein the interpretation change for identical instructions is on whether to add a shift operation in a data transfer instruction or data operation instruction.

14. A data processor comprising:
a CPU including an instruction control unit that decodes an instruction and produces a control signal and an execution unit that executes the instruction, based on the control signal;
an address bus coupled to the CPU; and
a data bus coupled to the CPU,
wherein the data processor has a mode register operable by instruction execution by the CPU,
wherein a first value set in the mode register indicates the instruction control unit a first operation mode in which an address space of a first capacity can be used as a data area, and
wherein a second value set in the mode register indicates the instruction control unit a second operation mode in which an address space of a second capacity smaller than the first capacity can be used as a data area.

15. The data processor according to claim 14,
wherein the mode register is a register allocated in the address space of the CPU in both the first operation mode and the second operation mode.

16. The data processor according to claim 14,
wherein the mode register is included within the CPU, and
wherein the data processor further includes an interrupt controller that can set values in the mode register according to interrupt factors.

17. The data processor according to claim 14,
wherein in interpretation of addressing modes, the instruction control unit, when the first operation mode is specified, makes general registers available for use with a first register length of the number of bits required to specify an address space of the first capacity, and, when the second operation mode is specified, makes the general registers available for use with a second register length of the number of bits required to specify an address space of the second capacity.
